(19) United States
(12) Patent Application Publication
(10) Pub. No.: US 2026/0056065 A1
(43) Pub. Date: Feb. 26, 2026

(54) THIAZOLOTHIAZOLE COMPOSITE MATERIALS AND METHODS EMPLOYING THE SAME

(71) Applicant: The University of North Carolina at Charlotte, Charlotte, NC (US)

(72) Inventors: Michael G. Walter, Charlotte, NC (US); Andrew R. Brotherton, Charlotte, NC (US); Tyler Joseph Adams, Charlotte, NC (US); Abhishek Shibu, Charlotte, NC (US)

(21) Appl. No.: 19/112,043

(22) PCT Filed: Sep. 15, 2023
(86) PCT No.: PCT/US23/74311

§ 371 Date: Mar. 14, 2025

Related U.S. Application Data
(60) Provisional application No. 63/406,953, filed on Sep. 15, 2022.

(51) Int. Cl. G01K 11/16; C09K 11/06

(52) U.S. Cl. CPC G01K 11/16; C09K 11/06; C09K 2211/1007; C09K 2211/1011; C09K 2211/1014; C09K 2211/1018

(57) ABSTRACT

A composite material, comprising one or more thiazolothiazole (TTz) compounds and one or more matrix materials is described herein. In another aspect, a sensor comprising a composite material comprising one or more thiazolothiazole (TTz) compounds and one or more matrix materials is described herein. In an aspect, a method of sensing is provided, comprising providing a composite material, exposing the composite material to a fluid, and detecting the presence or absence of an analyte in the fluid. In another aspect, a method of detecting a temperature change is provided, the method comprising providing a composite material, exposing the composite material to a first temperature, exposing the composite material to a second temperature different from the first temperature, and detecting a change from the first temperature to the second temperature.

### RELATED APPLICATION DATA

The present application claims priority pursuant to Article 8 of the Patent Cooperation Treaty to U.S. Provisional Patent Application Ser. No. 63/406,953, filed Sep. 15, 2022, which is incorporated herein by reference in its entirety.

### STATEMENT REGARDING FEDERALLY SPONSORED RESEARCH OR DEVELOPMENT

This application was made with government support under R15 CA192160 awarded by the National Institute of Health (NIH). The government has certain rights in the application.

### FIELD

The present invention relates generally to composite materials comprising thiazolothiazole compounds, as well as sensors, sensing methods, and detection methods employing the same.

### BACKGROUND

The detection and quantification of biological and chemical species are important requirements in many areas of science. For certain applications, optical detection methods offer higher sensitivity and selectivity.

Fluorescence-based measurements are important tools for biochemical sensing. The breadth and variety of optical fluorescence sensing using small-molecule fluorescent dye sensors are significant. Organic solvent vapor sensing using changes in molecular probe fluorescence is an area of intense development. However, many challenges still exist, such as enabling high sensitivity to a range of organic solvent vapors, sensor stability and reproducibility, and the ability to distinguish between compounds. Although a variety of promising systems have been evaluated, increased sensing functions and versatility are still needed.

Small molecule fluorophores are attractive molecular tools for environmental sensing applications and biosensing/bioimaging techniques, due to their high microenvironmental sensitivity, selectivity, and temporal resolution. Fluorescent molecules can either turn on/off their fluorescence, or chromically shift their emission through the binding or interaction of various metal ions, reactive oxygen species, organic toxins, or cell organelles/membranes, and can greatly enhance cell fluorescence microscopic imaging. Molecular sensors with large fluorescence Stokes shifts are advantageous for these applications due to a low overlap between excitation and emission. However, improved sensors are still needed.

### BRIEF SUMMARY

In one aspect, a composite material comprises a thiazolothiazole (TTz) compound of Formula I, Formula II, Formula III, Formula IV, or Formula V:

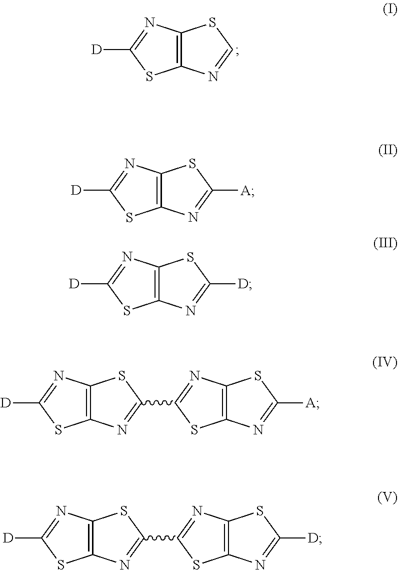

and further comprises a matrix material, wherein D is an electron donor, A is an electron acceptor, and [symbol] represents a connecting moiety. In one aspect, the TTz compound comprises the compound of Formula I. In another embodiment, the TTz compound comprises the compound of Formula II. In another embodiment, the TTz compound comprises the compound of Formula III. In another embodiment, the TTz compound comprises the compound of Formula IV. In yet another embodiment, the TTz compound comprises the compound of Formula V. In still other embodiments, the TTz compound comprises two or more of the compounds of Formulas I, II, III, IV, and/or V.

In one aspect, A comprises an aryl or heteroaryl moiety. In some embodiments, A comprises a nitroaromatic moiety. In some embodiments, the nitroaromatic moiety comprises a nitrophenyl moiety.

In one aspect, D comprises an aryl or heteroaryl moiety. In some embodiments, D comprises a dialkylamino moiety. In some embodiments, D comprises a diphenylamino moiety.

Moreover, it is generally to be understood in Formulas III and V that each D can be the same donor moiety or different donor moieties. That is, in each of these Formulas, each D can be independently selected to be a specific donor moiety. Thus, the D on the left of the structure can be considered to be D¹ and the D on the right of the structure can be considered to be D², where D¹ and D² can be the same or different, provided both are electron donating moieties.

In another aspect, at least one nitrogen of the TTz compound is substituted with a substituent selected from alkyl, heteroalkyl, cycloalkyl, heterocycloalkyl, alkenyl, heteroalkenyl, cycloalkenyl, heterocycloalkenyl, aryl, and heteroaryl. In some embodiments, the at least one nitrogen is substituted with a heteroalkyl substituent. In some embodiments, the heteroalkyl substituent comprises a quaternary amine moiety. In one aspect, more than one nitrogen of the TTz compound is substituted.

In another aspect, the TTz compound has the following structure:

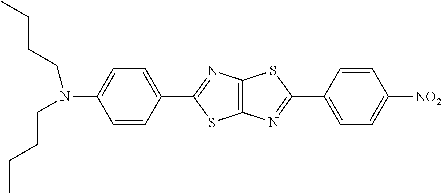 [SMILES: CCCCN(CCCC)c1ccc(-c2nc3sc(-c4ccc([N+](=O)[O-])cc4)nc3s2)cc1]

(which can be denoted as Bu₂N-TTz-NO₂).

In another aspect, the TTz compound has the following structure:

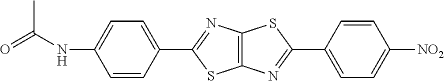 [SMILES: CC(=O)Nc1ccc(-c2nc3sc(-c4ccc([N+](=O)[O-])cc4)nc3s2)cc1]

(which can be denoted as AcNH-TTz-NO₂).

In yet another embodiment, the TTz compound has the following structure:

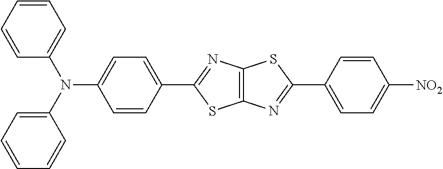 [SMILES: O=[N+]([O-])c1ccc(-c2nc3sc(-c4ccc(N(c5ccccc5)c5ccccc5)cc4)nc3s2)cc1]

(which can be denoted as Ph₂N-TTz-NO₂).

In another embodiment, the TTz compound has the following structure:

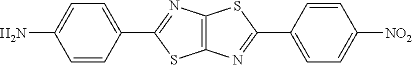 [SMILES: Nc1ccc(-c2nc3sc(-c4ccc([N+](=O)[O-])cc4)nc3s2)cc1]

(which can be denoted as H₂N-TTz-NO₂).

In another embodiment, the TTz compound has the following structure:

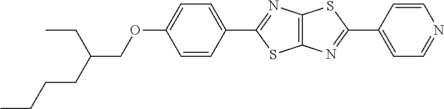 [SMILES: CCCCC(CC)COc1ccc(-c2nc3sc(-c4ccncc4)nc3s2)cc1]

(which can be denoted as EHOPh-TTz-Py).

In another embodiment, the TTz compound has the following structure:

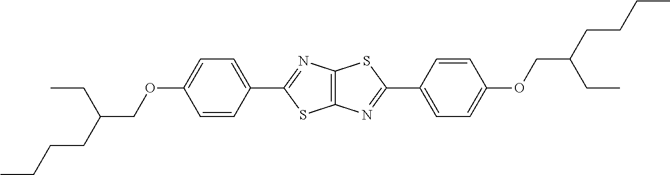 [SMILES: CCCCC(CC)COc1ccc(-c2nc3sc(-c4ccc(OCC(CC)CCCC)cc4)nc3s2)cc1]

(which can be denoted as (EHOPh)₂-TTz).

In another aspect, the TTz compound is a fluorophore.

In some embodiments, the TTz compound exhibits solvatofluorochromism.

In some embodiments, the TTz compound is embedded, encapsulated, or dispersed in the matrix material. In other embodiments, the TTz compound is covalently attached to the matrix material.

In one aspect, the matrix material is non-degrading to the TTz compound.

In some embodiments, the matrix material comprises a block copolymer. In some embodiments, the block copolymer is a styrene-isoprene-styrene (SIS) block copolymer.

In another aspect, the matrix material comprises a poly(dimethylsiloxane) (PDMS).

In yet another aspect, the matrix material comprises one or more of polymethyl methacrylate, poly(methyl methacrylate-co-methacrylic acid), polystyrene, polycarbonate, polypropylene, polyvinylpyrrolidone, poly(styrene-butadiene-styrene), polyethylene glycol, polyethylene glycol acrylate, polypropylene glycol, polyethylene glycol diacrylate, poly(4-vinylpyridine), polyethylene glycol methacrylate, poly(perfluorosulfonic acid-co-tetrafluoroethylene), polyvinyl alcohol, polyacrylonitrile, and polytripropylene glycol diacrylate, or combinations thereof.

In another aspect, the composite material further comprises a chromophore and/or a fluorophore different from the TTz compound.

In one aspect, the composite material further comprises a fluorophore different from the TTz compound.

In one aspect, a sensor is provided, the sensor comprising a composite material as described herein, comprising a thiazolothiazole (TTz) compound of Formula I, Formula II, Formula III, Formula IV, and/or Formula V above, and a matrix material. In some embodiments, the sensor is an optical sensor. In some embodiments, the sensor is reversible. In other embodiments, the sensor is irreversible.

In another aspect, a method of sensing is provided, comprising providing a composite material as described herein, comprising a thiazolothiazole (TTz) compound of Formula I, Formula II, Formula III, Formula IV, and/or Formula V above, and a matrix material, exposing the composite material to a fluid, and detecting the presence or absence of an analyte in the fluid. In some embodiments, detecting the presence or absence of the analyte comprises observing or detecting a color change or spectrographic change of the composite material. In one aspect, the fluid comprises a gas. In another aspect, the fluid comprises a liquid.

In some embodiments of a method of sensing provided herein, the matrix material of the composite material is permeable to the analyte. In some embodiments, the matrix material of the composite material is selectively permeable to the analyte. In some embodiments, the matrix material of the composite material is non-degrading to the TTz compound. In some embodiments, the analyte does not dissolve the matrix material of the composite material.

In another aspect, a method of detecting a temperature change is provided, the method comprising providing a composite material as described herein, comprising a thiazolothiazole (TTz) compound of Formula I, Formula II, Formula III, Formula IV, and/or Formula V above, and a matrix material, exposing the composite material to a first temperature, exposing the composite material to a second temperature different from the first temperature, and detecting a change from the first temperature to the second temperature.

These and other embodiments are further described in the following detailed description.

### BRIEF DESCRIPTION OF THE DRAWINGS

FIG. 1A illustrates an exemplary single-step, synthetic reaction to form asymmetric amino/nitrophenyl TTz fluorophores in accordance with embodiments described herein.

FIG. 1B illustrates four exemplary TTz compounds according to embodiments herein.

FIG. 1C illustrates the crystal structure and packing of a Ph₂N-TTz-NO₂ derivative.

FIG. 2A illustrates the absorbance of Bu₂N-TTz-NO₂ in hexane, and emission in various solvents.

FIG. 2B illustrates a Lippert-Mataga plot for Bu₂N-TTz-NO₂.

FIG. 2C illustrates a Lippert-Mataga plot for Ph₂N-TTz-NO₂.

FIG. 2D illustrates a Lippert-Mataga plot for AcNH-TTz-NO₂.

FIG. 2E illustrates a Lippert-Mataga plot for H₂N-TTz-NO₂.

FIG. 3A illustrates a modified relative energy Jablonski diagram for embodiments herein.

FIG. 3B illustrates the HOMO and excited state (FC) MO's of twisted and coplanar states for embodiments described in the present application.

FIG. 3C illustrates experimental and calculated spectra for Bu₂N-TTzNO₂ in chlorobenzene.

FIG. 4A illustrates normalized emission intensity spectra for Bu₂N-TTz-NO₂.

FIG. 4B illustrates the temperature-wavelength correlation profile of Bu₂N-TTz-NO₂ in toluene when T>−96° C. and T≤−96° C.

FIG. 5A illustrates a fluorescent film on a glass of TTz (1% wt. Ph₂N-TTz-NO₂) embedded in a SIS polymer, and exposure to organic solvent vapors to quench the fluorescence.

FIG. 5B illustrates the emission spectrum of a single exposure of Ph₂N-TTz-NO₂ to THF.

FIG. 5C illustrates a cycling plot of the maximum emission during sequential exposure (λₑₘᵢ=520 nm and λₑₓᵢ=445 nm) for embodiments herein.

FIG. 6A illustrates the crystal structure of Ph₂N-TTz-NO₂ and Ph₂N-TTz-Py derivatives.

FIG. 6B illustrates the emission spectrum of Ph₂N-TTz-NO₂ exposed to DCM vapors.

FIG. 6C illustrates the emission spectrum of Ph₂N-TTz-PY exposed to DCM vapors.

FIG. 7A illustrates the absorbance of H₂N-TTz-NO₂ in various solvents.

FIG. 7B illustrates the emission of H₂N-TTz-NO₂ in various solvents.

FIG. 8A illustrates the emission spectrum of 80 μM Bu₂N-TTz-NO₂ in Me-THE at various temperatures.

FIG. 8B illustrates the emission spectrum of 10 μM Bu₂N-TTz-NO₂ in Me-THF at various temperatures.

FIG. 8C illustrates the emission spectrum of 10 μM Bu₂N-TTz-NO₂ in Me-THF at various temperatures.

### DETAILED DESCRIPTION

Embodiments described herein may be understood more readily by reference to the following detailed description, taken in connection with the accompanying drawing figures, all of which form a part of this disclosure. It is to be understood that the present invention is not limited to the specific compositions, devices, methods, conditions and/or parameters described and/or shown herein, and that the terminology used herein is for the purpose of describing particular embodiments by way of example only, and is not intended to be limiting. It should be recognized that the embodiments herein are merely illustrative, and not all embodiments are described. Numerous modifications and adaptations will be readily apparent to those of skill in the art without departing from the spirit and scope of the invention.

As used herein, the term “and/or” includes any and all combinations of one or more of the associated listed items.

As used in this application, including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The ranges set forth herein include both the numbers at the end of each range and any and all conceivable numbers therebetween, as that is the very definition of a range. It is therefore to be understood that the ranges and limits mentioned herein include all ranges located within the prescribed limits (i.e., subranges). For example, a range of from “about 100 to about 200” is meant to also include ranges from 110 to 150, 170 to 190, 153 to 162, and 145.3 to 149.6, inter alia. Further, as another example, a limit of “up to about 7” also includes a limit of up to about 5, up to 3, and up to about 4.5, inter alia, as well as any and all ranges within the limit, such as from about 1 to about 5, and from about 3.2 to about 6.5, inter alia, as examples (provided that the minimum amount is at least a detectable or non-zero amount, such that an amount of “up to X” does not include an amount of zero). As another example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9, et cetera.

Unless otherwise indicated, all numbers expressing quantities of ingredients, properties, such as molecular weight, pH, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained. In some cases, the term “about” can be replaced with the term “within 5% of” or “within 1% of.”

As used herein, the terms “comprise”, “comprises”, “containing”; “has”, “have”, “having”; and “includes”, “include” and “including” are open-ended transition terms used to transition from a subject recited before the term to one or more elements recited after the term, where the element or elements listed after the transition term are not necessarily the only elements that make up the subject.

The term weight percent or wt. % means the weight of a given material relative to the weight of a resulting composition which includes the given material. For example, a composition having 10 wt. % of a component means that the composition includes 10 parts by weight of the component relative to 100 parts of the total weight of the resulting composition.

Unless otherwise defined, all terms (including technical and scientific terms) used herein have the same meaning as commonly understood by one having ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that a number of techniques, components, and steps are disclosed. Each of these has individual benefit and each can also be used in conjunction with one or more, or in some cases all, of the other disclosed techniques. Accordingly, for the sake of clarity, this description will refrain from repeating every possible combination of the individual steps or components in an unnecessary fashion. Nevertheless, the specification and claims should be read with the understanding that such combinations are entirely within the scope of the invention and the claims.

The present application is generally directed to composite materials comprising thiazolothiazole compounds, as well as sensors, sensing methods, and detection methods employing these materials. The materials, compositions, methods, and systems described herein are suitable for use in a wide variety of applications, including biological, environmental, and materials-related sensing processes.

Embodiments herein include push-pull materials (that is, materials having both electron-donating and electron-withdrawing groups) comprising different structures, such as for example, a donor/core-acceptor structure, a donor/core/acceptor structure, and a donor/core-acceptor/donor structure. In embodiments herein, the core may act as a structural bridge between groups. In one aspect, the core may comprise one thiazolothiazole moiety. In other embodiments, the core may comprise more than one thiazolothiazole moiety. In another aspect, the core may comprise moieties other than the one or more thiazolothiazole moiety. Without intending to be bound by theory, it is believed that the molecular arrangements of embodiments herein increase the quantum yield of the material due to a simultaneous increase in the energy of the singlet state and decrease in the energy of the triplet state. In addition, it appears that the structures of embodiments herein create a strong ICT (intramolecular charge transfer) excited state, and therefore, large transition dipole moment, resulting in a strong solvatofluorochromic effect, whereby emission red-shifts as the polarity of the surrounding environment increases. As described herein, this feature is advantageous for purposes of improving fluorescence imaging resolution due to an observed large Stokes shift that minimizes the overlap between excitation and emission.

The present inventors have developed novel and inventive composite materials comprising one or more TTz compounds, with, in some embodiments, much stronger transition dipole moments (Δμ) and/or greater optical sensing flexibility, which can in some cases achieve superior results in molecular sensing and other applications. Composite materials described herein, in some instances, can achieve advantageous and superior characteristics in, for example, fluorescent and optical organic vapor sensing applications. To this end, the present inventors have developed composite materials comprising one or more TTz compounds with, in some embodiments, strong intramolecular charge transfer coupled to programmable fluorescence quenching and strong transition dipole moments (Δμ). These materials can in some cases achieve superior optical sensing flexibility due to fluorescence quenching in a polar environment, as opposed to only spectra shifts.

The present inventors have also developed a new series of highly fluorescent, solvatofluorochromic, TTz compounds that can be accessed using a single-step reaction, and which can be synthesized with various donor groups, such as, for example, diphenylamine, dibutylamine, acetamide, amino, alkoxyphenyl, and nitrophenyl substituents.

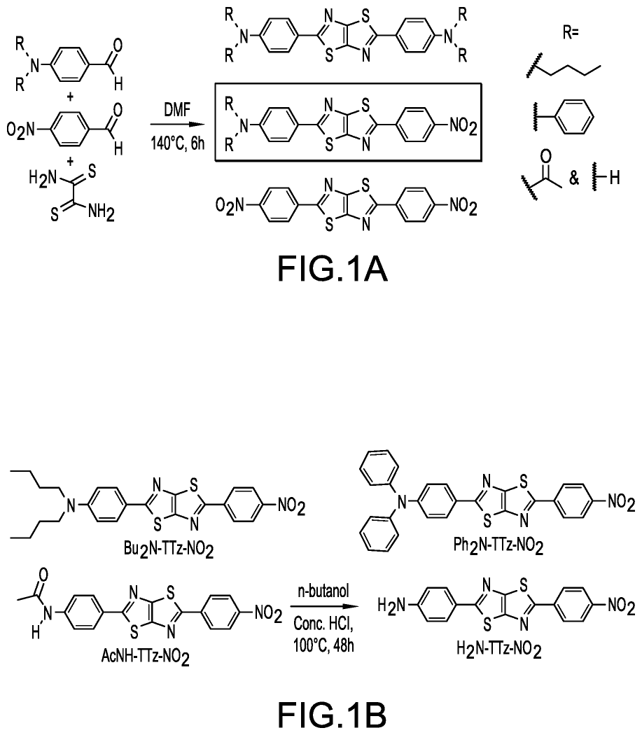

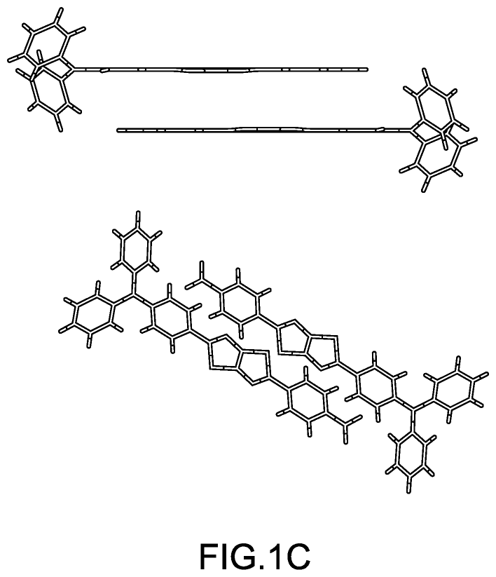

FIG. 1A shows an exemplary single-step, synthetic reaction to form asymmetric amino/nitrophenyl TTz fluorophores. In this non-limiting example embodiment, two aromatic aldehyde precursors are heated with dithiooxamide, resulting in one asymmetric and two symmetric TTz chromophores. It is noted that, typically, the addition of a nitrophenyl group to a chromophore promotes fluorescence quenching by intersystem crossing (ISC) to a non-radiative triplet state. However, it has unexpectedly been found that, in embodiments herein, the TTz bridge enables a nitrophenyl-containing push-pull TTz to achieve a selectively high fluorescence emission in non-polar solvents, and near complete quenching in polar solvents. A detailed computational analysis of the TTz spectra revealed a new phenomenon for these fluorescent chromophores, whereby long wavelength emission was suppressed, revealing a higher energy, twisted intramolecular charge transfer (TICT) state.

The present inventors have also developed sensors, such as a thin polymer film organic vapor sensor, as well as sensing applications and methods. A solvatofluorochromic effect was observed in some sample polymers with near complete quenching when exposed to volatile organic solvents, demonstrating the high-performance fluorescence sensing capabilities of the novel and inventive materials described herein.

### Definitions

The term “alkyl” as used herein, alone or in combination, refers to a straight or branched saturated hydrocarbon group. For example, an alkyl can be C₁-C₃₀. It is further to be understood that a “Cₙ” species contains exactly “n” carbon atoms (e.g., a C₃ alkyl group contains exactly 3 carbon atoms, as opposed to containing 2 or 4 carbon atoms, for example).

The term “alkenyl” as used herein, alone or in combination, refers to a straight or branched chain hydrocarbon group having at least one carbon-carbon double bond.

The term “aryl” as used herein, alone or in combination, refers to an aromatic monocyclic or multicyclic ring system optionally substituted with one or more ring substituents.

The term “cycloalkyl” as used herein, alone or in combination, refers to a non-aromatic, saturated mono- or multicyclic ring system optionally substituted with one or more ring substituents.

The term “cycloalkenyl” as used herein, alone or in combination, refers to a non-aromatic, mono- or multicyclic ring system having at least one carbon-carbon double bond, optionally substituted with one or more ring substituents.

The term “heterocycloalkyl” as used herein, alone or in combination, refers to a non-aromatic, saturated mono- or multicyclic ring system in which one or more of the atoms in the ring system is an element other than carbon, such as nitrogen, oxygen or sulfur, alone or in combination, and wherein the ring system is optionally substituted with one or more ring substituents.

The term “heterocycloalkenyl” as used herein, alone or in combination, refers to a non-aromatic, mono- or multicyclic ring system in which one or more of the atoms in the ring system is an element other than carbon, such as nitrogen, oxygen or sulfur, alone or in combination, and which contains at least one carbon-carbon double bond in the ring system and wherein the ring system is optionally substituted with one or more ring substituents.

The term “heteroalkyl” as used herein, alone or in combination, refers to an alkyl moiety as defined above, having one or more carbon atoms, for example one, two or three carbon atoms, replaced with one or more heteroatoms, which may be the same or different.

The term “multicyclic ring system” as used herein, alone or in combination, refers to fused ring systems or non-fused ring systems linked together by one or more spacer moieties.

The term “electron donor” as used herein, alone or in combination, refers to a chemical moiety, entity or compound that donates electrons to another moiety, entity or compound. A reducing agent is considered an electron donor.

The term “electron acceptor” as used herein, alone or in combination, refers to a chemical moiety, entity or compound which can receive or accept electrons from another moiety, entity or compound. An oxidizing agent is considered an electron acceptor.

The term “chromophore” as used herein, alone or in combination, refers to any species that exhibits a color when observed by the unaided, healthy eye of a human observer, wherein the observed color can be due to emission, absorption, or any other mechanism.

The term “fluorophore” as used herein, alone or in combination, refers to any species that emits light, whether by fluorescence, phosphorescence, or any other mechanism.

The term “sensor” as used herein, alone or in combination, refers to an analyzer that responds to a particular analyte in a selective way and transforms input information or data into a discernible signal, such as, for example, a visible signal.

The term “analyte” as used herein, alone or in combination, refers to a substance or chemical constituent in a fluid whose presence, absence, or concentration can be analyzed, measured, detected, or determined.

The term “reversibility” as used herein, alone or in combination, refers to the ability of a sensor to return to its original baseline condition after being exposed to an analyte, such that the sensor can be used to detect another detection event.

The term “reversible sensor” as used herein, alone or in combination, refers to a sensor or sensor signal which returns to its original or baseline condition after exposure to and/or upon removal of an analyte, without exhibiting physical or chemical changes when comparing the sensor before and after the initial analyte detection and removal event. A reversible sensor can be used again (e.g., exposed to the same or a different species of analyte more than once).

The term “irreversible sensor” as used herein, alone or in combination, refers to a sensor or sensor signal which does not return to its original or baseline condition after exposure to and/or upon removal of an analyte. Because an irreversible sensor does not return to its original or baseline condition after exposure to an analyte, an irreversible sensor cannot be reused in the same way as it is used to detect the presence of the analyte originally.

The term “permeation” as used herein, alone or in combination, refers to the transport of a permeant across a membrane or interface.

The term “permeable” as used herein, alone or in combination, refers to a property of a material which allows passage of substances therethrough. For example, a matrix material that is permeable to an analyte can permit the analyte to enter, exit, and/or pass all the way through the matrix material (e.g., by diffusion).

The term “selectively permeable” as used herein, alone or in combination, refers to a property of a material which allows only certain substances or materials to enter, exit and/or move through it, while inhibiting or blocking the passage of others. For example, a matrix material that is selectively permeable to an analyte will permit the analyte to enter, exit, and/or pass through the matrix material, while inhibiting or blocking the passage of other substances or materials.

The term “fluid” as used herein, alone or in combination, refers to a substance that flows, deforms, and changes shape when subjected to a force or stress. Fluids do not have a fixed shape. Liquids, gases (such as air or ambient atmosphere), and plasma are considered as fluids.

The terms “thermochromic” or “thermochromism” as used herein, refer to a change in the color of a compound or material when the compound or material is exposed to a temperature change, such as heating or cooling.

The terms “solvatochromic” and “solvatochromism” as used herein, refer to the characteristic of a chromophore to undergo a shift in its absorption and/or emission wavelengths, which is induced by the action of a solvent.

The terms “solvatofluorochromic” and “solvatofluorochromism” as used herein, refer to the characteristic of a chromophore to undergo a shift in emission spectra, which is induced by the action of a solvent.

### I. Composite Materials

Composite materials are described herein, comprising one or more thiazolothiazole (TTz) compound, and one or more matrix material. In embodiments herein, the TTz compound may comprise one or more similar or different thiazolothiazole moieties. The matrix material may also comprise or be formed from one or more chemical species (e.g., a polymeric matrix material can be formed from a single polymeric material or from a combination of two or more polymeric materials). As such, in some embodiments, the composite materials described herein may include a single TTz compound and a single matrix material; a combination of TTz compounds and a single matrix material; a single TTz compound and a combination of matrix materials; or a combination of TTz compounds and a combination of matrix materials. Moreover, in some embodiments, the composite material may include additional components, in addition to the one or more TTz compound and the one or more matrix material. For instance, in some embodiments, the composite material may include non-TTz moieties, compounds, or species, as described further herein.

The one or more TTz compound(s) in a composite material described herein may comprise various different architectures.

For instance, in one aspect, the thiazolothiazole (TTz) compound(s) may comprise a Donor (D)-Acceptor (A) architecture with a thiazolothiazole core acting as an electron acceptor moiety. For example, in some embodiments, a TTz compound may have the architecture depicted in Formula (I) below, wherein D is an electron donor moiety, and the TTz core compound acts as an electron acceptor moiety:

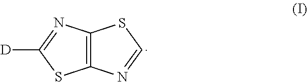

In some embodiments, the TTz compound(s) may act as a core or structural bridge (a structural bridge can include various atoms and/or bonds that connect one part of a molecule to another part of the molecule) between other components.

For instance, in some embodiments, the thiazolothiazole (TTz) compound acts as a structural bridge between an electron donor moiety and an electron acceptor moiety. For example, in some embodiments, a TTz compound in the composite material is a compound of Formula II, wherein D is an electron donor moiety, and A is an electron acceptor moiety:

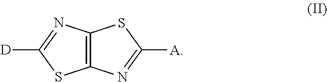

In some embodiments, the thiazolothiazole (TTz) compound acts as both a structural bridge and as an electron acceptor moiety, linking an electron donor moiety to another electron donor moiety. For instance, in some embodiments, a TTz compound is a compound of Formula (III):

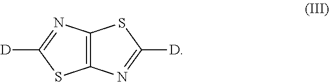

As noted above, in some embodiments, multiple TTz compounds may be present as the core portion of the compound. In these embodiments, each of the multiple TTz compounds may be the same or different.

In some embodiments, multiple TTz moieties present as the core portion of the compound are connected by a connecting moiety (e.g., a moiety used for linking one moiety to another moiety), and may act as a structural bridge between an electron donor moiety and an electron acceptor moiety. The connecting moiety may be any chemical group or moiety useful for linking one TTz moiety to another moiety. For example, a connecting moiety can comprise one or more aromatic rings (e.g., fused or not), one or more hydrocarbyl moieties (e.g., alkyl, alkenyl, alkynyl, etc.), or other organic moieties (e.g., carbonyl, esters, amides, urethane, etc.).

In some embodiments, a TTz compound is a compound of Formula (IV), wherein [symbol] represents the connecting moiety:

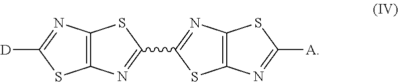

In other embodiments, multiple TTz moieties present as the core portion of the compound may act as both a structural bridge and as an electron acceptor, linking an electron donor moiety to another electron donor moiety. For instance, in some embodiments, a TTz compound is a compound of Formula (V), wherein [symbol] represents the connecting moiety:

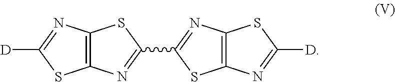

It is further to be understood that electron donor (D) and electron acceptor (A) moieties can be selected to provide materials with the desired structure and associated properties described herein.

Moreover, it is generally to be understood in Formulas III and V that each D can be the same donor moiety or different donor moieties. That is, in each of these Formulas, each D can be independently selected to be a specific donor moiety. Thus, the D on the left of the structure can be considered to be D¹ and the D on the right of the structure can be considered to be D², where D¹ and D² can be the same or different, provided both are electron donating moieties.

In some embodiments, D and A are independently selected from aryl and heteroaryl.

In some embodiments, A is selected from monocyclic, bicyclic or polycyclic aryl or monocyclic, bicyclic or polycyclic heteroaryl. The aryl and heteroaryl structures can be fused or linked. A, for example, can be selected from pyridine, substituted pyridine, pyrrole, aniline, thiophene, ethlyenedioxythiophene, p-phenylenevinylene, benzothiadiazole, pydridinethiadiazole, pyridineselenadiazole, benzoxadiazole, and benzoselenadiazole. In some embodiments, A comprises a nitroaromatic moiety. Nitroaromatic compounds are defined as organic molecules comprising at least one nitro group (—NO₂) attached to an aromatic ring. Any nitroaromatic moiety suitable for use in the manufacture of dyes may be employed. In some embodiments, the nitroaromatic moiety comprises a nitrophenyl moiety.

In some embodiments, each D is selected from monocyclic, bicyclic or polycyclic aryl or monocyclic, bicyclic or polycyclic heteroaryl. The aryl and heteroaryl structures can be fused or linked. In some embodiments, each D can be selected from aniline, pyrrole, thiophene, 3-substituted thiophene, bithiophene, terthiophene, selenophene, 3-substituted selenophene, isothianaphthene, p-phenylenevinylene, and ethylenedioxythiophene. In some embodiments, D comprises a dialkylamino moiety. In some embodiments, D is selected from amino moieties, diphenylamino moieties, dibutylamino moieties, amines, and amides. In some embodiments, D is acetamide. In some embodiments, D comprises an alkoxyphenyl moiety.

In some embodiments, one or more of the nitrogen atoms of a thiazolothiazole compound in the composite material are substituted. In some embodiments, the one or more nitrogen atoms may be substituted with a substituent selected from alkyl, heteroalkyl, cycloalkyl, heterocycloalkyl, alkenyl, heteroalkenyl, cycloalkenyl, heterocycloalkenyl, aryl, and heteroaryl. In some embodiments herein, substitution on one or more of the nitrogen atoms can be employed to alter the hydrophilic or hydrophobic nature of the material. For example, substitution on the nitrogen can produce a quaternary amine, enabling various salt structures. When more than one nitrogen is substituted, the substituents may be the same or different. Additionally, quaternary amines and/or other charged structures may be imparted by substituents coupled to the ring nitrogen. In some embodiments, for example, the TTz compounds are zwitterionic dyes.

FIG. 1A shows an exemplary single-step, synthetic reaction that forms amino/nitrophenyl TTz fluorophores in accordance with some embodiments described herein. In this exemplary reaction, two aromatic aldehyde precursors are heated with dithiooxamide, resulting in one asymmetric and two symmetric TTz chromophores. The asymmetric TTz compound can be a push-pull compound.

FIG. 1B shows four non-limiting examples of TTz compounds suitable for use in some embodiments of the composite materials described herein. For instance, in some embodiments, the TTz compound has the following structure:

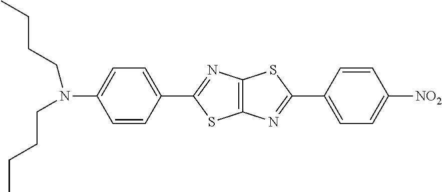 [SMILES: CCCCN(CCCC)c1ccc(-c2nc3sc(-c4ccc([N+](=O)[O-])cc4)nc3s2)cc1]

(which can be denoted as Bu₂N-TTz-NO₂).

In some embodiments, the TTz compound in the composite material has the following structure:

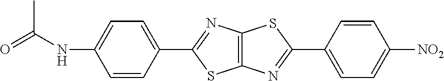 [SMILES: CC(=O)Nc1ccc(-c2nc3sc(-c4ccc([N+](=O)[O-])cc4)nc3s2)cc1]

(which can be denoted as AcNH-TTz-NO₂).

In some embodiments, the TTz compound has the following structure:

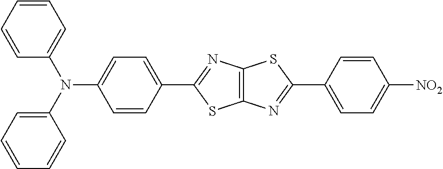 [SMILES: O=[N+]([O-])c1ccc(-c2nc3sc(-c4ccc(N(c5ccccc5)c5ccccc5)cc4)nc3s2)cc1]

(which can be denoted as Ph₂N-TTz-NO₂).

In other embodiments, the TTz compound has the following structure:

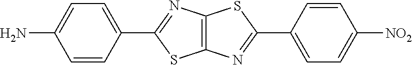 [SMILES: Nc1ccc(-c2nc3sc(-c4ccc([N+](=O)[O-])cc4)nc3s2)cc1]

(which can be denoted as H₂N-TTz-NO₂).

In addition to the exemplary compounds shown in FIG. 1B, other TTz compounds may also be suitable for use in the composite materials described herein, and may be made in an analogous manner to the compounds described in FIG. 1B. Additional non-limiting examples of TTz compounds suitable for use in the composite materials described herein include:

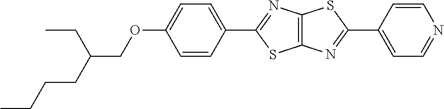 [SMILES: CCCCC(CC)COc1ccc(-c2nc3sc(-c4ccncc4)nc3s2)cc1]

(which can be denoted as EHOPh-TTz-Py), and

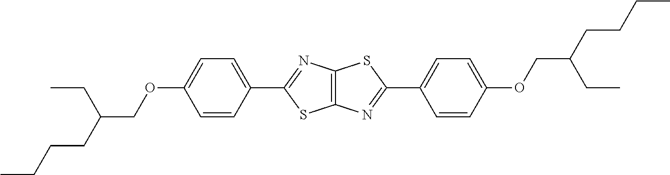 [SMILES: CCCCC(CC)COc1ccc(-c2nc3sc(-c4ccc(OCC(CC)CCCC)cc4)nc3s2)cc1]

(which can be denoted as (EHOPh)₂-TTz).

The compounds embodied in FIGS. 1A and 1B were synthesized with a ratio of donor aldehydes (D-Bz-CHO) to acceptor aldehydes (A-Bz-CHO) to dithiooxamide of 3.5:1:1.25. Experimental testing conducted by the inventors showed that the crystal structure of the TTz compounds embodied in these figures exhibited a highly planar phenyl/TTz core, as shown in FIG. 1C. A molecular packing diagram for the compounds embodied in these figures showed an alternating alignment of neighboring TTz electron-donating and electron-withdrawing groups, and a fluorescence microscope image of a single crystal thereof showed bright red emission of the single crystals in the solid state.

TTz bridges connecting functional groups (e.g., donor groups, acceptor groups, etc.) in embodiments herein can be varied with different planarity and structural conjugations, to tune for specific applications. Thus, it is to be understood that the exemplary components of FIGS. 1A and 1B are non-limiting examples of TTz compounds that may be used in the composite materials described herein.

In some embodiments, the one or more TTz compounds in the composite materials herein may be fluorophores. In some embodiments, a fluorophore can have a peak absorption in the range of 360 nm to 650 nm, and a peak emission in the range of 420 nm to 800 nm. In some embodiments, the absorption profile of the fluorophore does not overlap or substantially overlap with the emission profile. Absorption and emission profiles of a fluorophere do not substantially overlap if less than 10 percent or less than 5 percent of the profiles have overlap. Additionally, the fluorophore can exhibit solvent-dependent fluorescence lifetimes. Fluorescence lifetime can vary relative to solvent polarity, in some embodiments. The fluorophore can display solvatofluorochromism, exhibiting a Stokes shift of 0.25 to 0.75 eV, in some embodiments. In some embodiments herein, a TTz compound can exhibit photoluminescent (PL) quantum yields greater than 80 percent, greater than 85 percent, or greater than 90 percent in non-polar solvents.

Dependent on donor and/or acceptor moiety selections, TTz compounds described herein can be amphiphilic in some embodiments. Without being bound by theory, it is believed that the amphiphilic nature of a dye can facilitate interaction with various polymeric structures (such as may be present in a matrix material described herein) or biomolecular structures, including phospholipid bilayers of cells, and/or liposomes. Additionally, in one aspect, TTz compounds described herein can be functionalized with various click chemistries and/or other targeting moieties for covalent bonding to a matrix material or for otherwise localizing in a desired environment for labeling. Click chemistry moieties include, but are not limited to, bicyclononyne (BCN), dibenzocyclooctyne (DBCO), trans-cyclooctyne (TCO), tetrazine, alkyne, and azide, in some embodiments.

In some embodiments, TTz compounds described herein have a difference between the highest occupied molecular orbital (HOMO) and lowest unoccupied molecular orbital (LUMO) of at least 1.2 eV. In some embodiments, the HOMO-LUMO offset or gap is 1.2 eV to 5 eV. In some embodiments, the HOMO-LUMO offset has a value of 1.5 eV to 5 eV. In some embodiments, the HOMO-LUMO offset has a value of 2-5 eV, 2.5-5 eV, 3-5 eV, 2-4 eV, or 3-4 eV.

In some embodiments, TTz compounds described herein exhibit a change in dipole moment between ground and excited states of at least 5 debye (D). In some embodiments, the change in dipole moment is from 5 D to 40 D. In some embodiments, the change in dipole moment is from 10 D to 40 D, 13 D to 40 D, 14 D to 40 D, 14.5 D to 40 D, 15 D to 40 D, 16 D to 40 D, 17 D to 40 D, or 18 D to 40 D. In some embodiments, a TTz compound can exhibit both a HOMO-LUMO difference and change in dipole moment as described herein.

The one or more TTz compound(s) can be present in a composite material described herein in any amount not inconsistent with the objectives of the present disclosure. For example, in some cases, the one or more TTz compound(s) or component(s) is/are present in the composite material in an amount of up to 15 wt. %, up to 10 wt. %, up to 9 wt. %, up to 8 wt. %, up to 7 wt. %, up to 6 wt. %, up to 5 wt. %, up to 4 wt. %, up to 3 wt. %, up to 2 wt. %, up to 1 wt. %, up to 0.5 wt. %, or up to 0.1 wt. %, based on the total weight of the composite material. In some instances, the composite material comprises at least 0.001 wt. %, at least 0.01 wt. %, or at least 0.1 wt. % of the one or more TTz compound(s). In some instances, the one or more TTz compound(s) or component(s) is/are present in the composite material described herein in an amount of 0.001-15 wt. %, based on the total weight of the composite material. In some instances, the one or more TTz compound(s) or component(s) is/are present in the composite material described herein in an amount of 0.001-10 wt. %, based on the total weight of the composite material. In some embodiments, the one or more TTz compound(s) or component(s) is/are present in the composite material described herein in an amount of 0.001-9 wt. %, 0.001-8 wt. %, 0.001-7 wt. %, 0.001-6 wt. %, 0.001-5 wt. %, 0.001-4 wt. %, 0.001-3 wt. %, 0.001-2 wt. %, 0.001-1 wt. %, 0.001-0.5 wt. %, 0.001-0.1 wt. %, 0.01-15 wt. %, 0.01-10 wt. %, 0.01-9 wt. %, 0.01-8 wt. %, 0.01-7 wt. %, 0.01-6 wt. %, 0.01-5 wt. %, 0.01-4 wt. %, 0.01-3 wt. %, 0.01-2 wt. %, 0.01-1 wt. %, 0.01-0.5 wt. %, 0.01-0.1 wt. %, 0.1-15 wt. %, 0.1-10 wt. %, 0.1-9 wt. %, 0.1-8 wt. %, 0.1-7 wt. %, 0.1-6 wt. %, 0.1-5 wt. %, 0.1-4 wt. %, 0.1-3 wt. %, 0.1-2 wt. %, 0.1-1 wt. %, or 0.1-0.5 wt. %, based on the total weight of the composite material.

The composite materials described herein also comprise a matrix material. In some embodiments, the matrix material comprises a polymer. In some embodiments, the polymer may be or comprise an organic polymer, an inorganic polymer, or a hybrid organic/inorganic polymer. In some embodiments, the polymer can be or comprise a conducting polymer, a hydrogel, a molecularly imprinted polymer, a polymer composite, or a polymer nanocomposite.

In some embodiments, the polymer may be a porous polymer. In some embodiments, the polymer may be a microporous polymer. In other embodiments, the polymer may be a mesoporous polymer.

In some embodiments, the matrix material comprises an elastomer polymer. In some embodiments, the elastomer is a thermoplastic elastomer.

In some embodiments, the matrix material comprises a block copolymer. In some embodiments, the matrix material comprises a styrenic block copolymer. In some embodiments, the matrix material comprises one or more styrene-butadiene block copolymers, styrene-isoprene-styrene block copolymers, polyisoprene, polybutadiene, ethylene propylene polymers, ethylene propylene diene polymers, silicone elastomers, fluoroelastomers, polyurethane elastomers, and/or nitrile elastomers, or combinations thereof.

Non-limiting examples of matrix materials suitable for use in some embodiments of composite materials described herein include styrene-isoprene-styrene (SIS) block copolymers, poly(dimethylsiloxane) (PDMS), polymethyl methacrylate, poly(methyl methacrylate-co-methacrylic acid), polystyrene, polycarbonate, polypropylene, polyvinylpyrrolidone, poly(styrene-butadiene-styrene), polyethylene glycol, polyethylene glycol acrylate, polypropylene glycol, polyethylene glycol diacrylate, poly(4-vinylpyridine), polyethylene glycol methacrylate, poly(perfluorosulfonic acid-co-tetrafluoroethylene), polyvinyl alcohol, polyacrylonitrile, and polytripropylene glycol diacrylate. In some embodiments, the matrix material may include multiple matrix components as described herein, such as a combination of two or more of the foregoing polymers.

The matrix material or component can be present in a composite material described herein in any amount not inconsistent with the objectives of the present disclosure. For example, in some cases, the matrix material or component is present in an amount of up to 99.999 wt. %, up to 99.99 wt. %, up to 99.9 wt. %, up to 99 wt. %, up to 98 wt. %, up to 97 wt. %, up to 96 wt. %, up to 95 wt. %, up to 94 wt. %, up to 93 wt. %, up to 92 wt. %, up to 91 wt. %, or up to 90 wt. %, based on the total weight of the composite material. In some embodiments, the matrix material or component is present in an amount of at least 50 wt. %, at least 75 wt. %, at least 80 wt. %, at least 85 wt. %, at least 90 wt. %, at least 91 wt. %, at least 92 wt. %, at least 93 wt. %, at least 94 wt. %, or at least 95 wt. %, based on the total weight of the composite material. In some instances, the matrix material or component is present in a composite material described herein in an amount of 80-99.999 wt. %, 80-99.99 wt. %, 80-99.9 wt. %, 80-99 wt. %, 80-98 wt. %, 80-97 wt. %, 80-96 wt. %, 80-95 wt. %, 80-94 wt. %, 80-93 wt. %, 80-92 wt. %, 80-91 wt. %, or 80-90 wt. %, based on the total weight of the composite material. In some embodiments, the matrix material or component is present in a composite material described herein in an amount of 85-99.999 wt. %, 85-99.99 wt. %, 85-99.9 wt. %, 85-99 wt. %, 85-98 wt. %, 85-97 wt. %, 85-96 wt. %, 85-95 wt. %, 85-94 wt. %, 85-93 wt. %, 85-92 wt. %, 85-91 wt. %, or 85-90 wt. %, based on the total weight of the composite material. In some embodiments, the matrix material or component is present in a composite material described herein in an amount of 90-99.999 wt. %, 90-99.99 wt. %, 90-99.9 wt. %, 90-99 wt. %, 90-98 wt. %, 90-97 wt. %, 90-96 wt. %, 90-95 wt. %, 90-94 wt. %, 90-93 wt. %, 90-92 wt. %, or 90-91 wt. %, based on the total weight of the composite material. In some embodiments, the matrix material or component is present in a composite material described herein in an amount of 95-99.999 wt. %, 95-99.99 wt. %, 95-99.9 wt. %, 95-99 wt. %, 95-98 wt. %, 97-99.999 wt. %, 97-99.99 wt. %, 97-99.9 wt. %, 97-99 wt. %, 97-98 wt. %, 98-99.999 wt. %, 98-99.99 wt. %, 98-99.9 wt. %, 98-99 wt. %, 99-99.999 wt. %, 99-99.99 wt. %, or 99-99.9 wt. %, based on the total weight of the composite material.

In some embodiments herein, the one or more TTz compound(s) is/are incorporated in the matrix material. For example, incorporation of a TTz compound into the matrix material may be achieved by adsorption, covalent binding, and/or encapsulation.

For example, in some embodiments, the one or more TTz compound(s) is/are embedded in the matrix material. In some such cases, the TTz compound penetrates into the matrix material, such that the compound is incorporated inside the interior of the matrix material. Without being bound by theory, it is believed that embedding a compound or dye inside a matrix can prevent or minimize the quantum yield of the compound or dye from being affected by chemical degradation due to interactions with the surrounding medium.

In other embodiments, a TTz compound is covalently attached to the matrix material. Not intending to be bound by theory, it is believed that covalent binding can prevent aggregation of TTz-containing molecules, which can directly affect fluorescent intensity (e.g., due to self-quenching). As understood by one of ordinary skill in the art, covalent attachment of TTz compounds to a matrix material can be accomplished in various ways and through various approaches. For example, in some cases, covalent bonding of a TTz compound or moiety to a matrix material is carried out by polymerizing a TTz compound with monomers that form the matrix material. In some such embodiments, for instance, the TTz compound includes a polymerizable moiety (e.g., an ethylenically unsaturated moiety such as a (meth)acrylate moiety as a side group), and this polymerizable moiety of the TTz compound participates in alkene or (meth)acrylate polymerization of matrix material monomers. In other implementations, a TTz compound is covalently attached to a matrix material by a (cross)coupling reaction of the TTz compound with a preformed polymer (e.g., by reacting with a pendant or surface functional group of the pre-formed polymer). In some embodiments described herein, a TTz compound is covalently attached to the matrix through side groups of the A or D species. In some embodiments, a TTz compound is covalently attached to the matrix from a phenyl of the TTz compound, as shown in FIG. 1B.

In one aspect, a matrix material is non-degrading to a TTz compound. In this context, degradation refers to a reduction in the properties of a material, caused by changes in its chemical composition. For example, in some embodiments, such chemical degradation involves covalent-bond breakage within a species. As such, a matrix material that is non-degrading to a TTz compound as described herein, in some cases, would not react with or break covalent bonds within the TTz compound under normal conditions (e.g., standard temperature and pressure conditions).

In addition to the one or more TTz compound(s) and matrix material(s), a composite material described herein may optionally include additional components, such as one or more chromophore and/or one or more fluorophore. The one or more chromophore and/or the one or more fluorophore may be different from the one or more TTz compound(s).

For example, in some embodiments, the composite material can include one or more dyes. Non-limiting examples of dyes which may be present in the composite materials described herein include rhodamine, fluorescein, coumarin, diphenylanthracene, tartrazine, and rubrene.

The one or more chromophore(s) and/or fluorophore(s) can be present in the composite material described herein in any amount not inconsistent with the objectives of the present disclosure. For example, in some cases, the one or more additional chromophore(s) and/or fluorophore(s) is/are present in an amount of no greater than 10 wt. %, no greater than 5 wt. %, no greater than 4 wt. %, no greater than 3 wt. %, no greater than 2 wt. %, no greater than 1 wt. %, no greater than 0.5 wt. %, or no greater than 0.1 wt. %, based on the total weight of the composite material. In some instances, the one or more chromophore(s) and/or fluorophore(s) is/are present in a composite material described herein in an amount of 0.001-10 wt. %, 0.001-5 wt. %, 0.001-4 wt. %, 0.001-3 wt. %, 0.001-2 wt. %, 0.001-1 wt. %, 0.001-0.5 wt. %, 0.001-0.1 wt. %, 0.01-10 wt. %, 0.01-5 wt. %, 0.01-4 wt. %, 0.01-3 wt. %, 0.01-2 wt. %, 0.01-1 wt. %, 0.01-0.5 wt. %, 0.01-0.1 wt. %, 0.1-10 wt. %, 0.1-5 wt. %, 0.1-4 wt. %, 0.1-3 wt. %, 0.1-2 wt. %, 0.1-1 wt. %, or 0.1-0.5 wt. %, based on the total weight of the composite material.

In some embodiments, the composite materials described herein may be in the form of a film. In some embodiments, the composite materials may be in the form of a thin film. When a film is formed comprising a composite material as described herein, the film may have a thickness of, for example, at least 0.1 μm, at least 0.5 μm, at least 1 μm, at least 5 μm, at least 10 μm, at least 15 μm, at least 20 μm, or at least 25 μm, in some embodiments. The film may have a thickness of up to 500 μm, up to 450 μm, up to 400 μm, up to 350 μm, up to 300 μm, up to 250 μm, up to 200 μm, up to 150 μm, or up to 100 μm. In some instances, a film may have a thickness of 0.1-500 μm, 0.1-450 μm, 0.1-400 μm, 0.1-350 μm, 0.1-300 μm, 0.1-250 μm, 0.1-200 μm, 0.1-150 μm, 0.1-100 μm, 0.5-500 μm, 0.5-450 μm, 0.5-400 μm, 0.5-350 μm, 0.5-300 μm, 0.5-250 μm, 0.5-200 μm, 0.5-150 μm, 0.5-100 μm, 1-500 μm, 1-450 μm, 1-400 μm, 1-350 μm, 1-300 μm, 1-250 μm, 1-200 μm, 1-150 μm, 1-100 μm, 5-500 μm, 10-500 μm, 15-500 μm, 20-500 μm, or 25-500 μm.

In some embodiments, composite materials as described herein can achieve superior fluorescent properties, as described in detail in the Examples section. For instance, in some embodiments, composite materials can achieve spectral shifts of up to 0.87 eV, including spectral shifts from 0.13 eV to 0.87 eV. In embodiments, composite materials described herein can also achieve large transition dipole moments Au. In embodiments herein, composite materials exhibit superior tunable fluorescence in films and dispersions, photo-triggered reversible fluorescence, and pH triggered fluorescence.

As such, composite materials as described herein can be employed in a variety of applications. For example, in some embodiments, composite materials described herein can provide high fluorescent outputs to monitor a wide range of biological, environmental, or materials-related sensing processes. In some embodiments, composite materials described herein can be used for thermochromic, solvatochromic, and/or solvatofluorochromic applications. Composite materials described herein may be applied in a variety of sensing applications, including solvent polarity, temperature, pH, and cell membrane potential sensitivity applications. In some embodiments, composite materials described herein may be applied in light emitting diode (LED) technologies, organic light emitting diodes (OLED), white-light emitting diodes (WLED), light-based therapy (phototherapy), signage (including stimuli-responsive and adaptive signage), optical filters, steganography, encryption, anti-counterfeiting, medical devices and/or diagnostics, paints, and pigments, among others. In some applications, a mixture of two or more composite materials as described herein may be employed, depending on the application thereof.

### II. Sensors

In one aspect, sensors are provided, comprising a composite material as described herein as an active sensing component. A composite material described herein may also be employed in other advanced electronic measuring devices.

In some cases, sensors described herein can detect the presence, absence, concentration, or change in concentration of an analyte, as described further below. In some instances, a sensor described herein monitors or detects an analyte, the absence of the analyte, the concentration of the analyte, or a concentration change thereof, based on an absorption profile and/or an emission profile of a composite material described herein. For example, in some cases, a fluorescence spectral shift and/or intensity change is used. In some instances, intensity, lifetime, and/or polarization of emitted light is used. Thus, in some embodiments, a sensor described herein is an optical sensor. A sensor described herein may also be a chemo-responsive sensor.

Further, in some embodiments, a sensor described herein may be reversible. In other embodiments, a sensor described herein is irreversible.

In some embodiments, the analyte can be a solvent. In some embodiments, the analyte is a volatile organic solvent. Non-limiting examples of analytes suitable for use in methods of sensing as described herein include ammonia, hydrogen, toluene, chloroform, benzonitrile (Bz-CN), dichloromethane, hexane, benzene, chlorobenzene (Cl-Bz), tetrahydrofuran (THF), dioxane, dimethyl ether, anisole, ethyl alcohol (EtOH), toluene, trichloromethane (CHCl₃), acetone, and acetonitrile. Thus, in some cases, a sensor described herein is an organic vapor optical sensor that indicates the presence, absence, or concentration of an organic vapor through a visual or optical display or signal (such as a color change or a change from a fluorescence ‘off’ state to a fluorescence ‘on’ state).

As stated above, a sensor described herein can use a composite material described herein as an active sensing component that enables the sensor to respond to an analyte. Any composite material described herein (e.g., in Section I above or in the Examples below) may be used as an active sensing component of a sensor described herein.

In addition to an active sensing component, a sensor described herein may include other components. For example, in some embodiments, a sensor comprises a sensing area. In some embodiments, a sensor has a reference area. In some embodiments, the sensing area may be located within a sensing chamber.

### III. Methods of Sensing

Methods of sensing are also provided herein.

In one aspect, a method of sensing comprises detecting the presence, absence, concentration, or change in concentration of an analyte. In some embodiments, a method of sensing comprises providing a composite material as described herein, exposing the composite material to a fluid, and detecting the presence, absence, concentration, or change in concentration of the analyte in the fluid. Any composite material described herein (e.g., in Section I above or in the Examples below) may be employed in the methods of sensing herein.

In some embodiments, a method of sensing comprises utilizing the sensor described in Section II above to detect the presence, absence, concentration, or change in concentration of the analyte.

In some embodiments, a method of sensing includes obtaining one or more signals from the analyte, and transducing the one or more signals into one or more optical signals, such as absorbance, fluorescence, and/or luminescence, among others. For instance, in some instances, a method of sensing detects the presence, absence, concentration, or change in concentration of the analyte based on an absorption profile and/or an emission profile of a composite material described herein. In one aspect, detection is based on a fluorescence spectral shift and/or intensity change.

In some embodiments, a method of sensing detects changes in fluorescent signals such as quenching, enhancement, and/or color changes. In some embodiments, detecting the presence or absence of the analyte comprises observing and/or detecting a color change of the composite material. In some embodiments, detecting the presence or absence of the analyte comprises observing and/or detecting one or more spectrographic changes of the composite material. Non-limiting examples of spectrographic changes include changes in the electromagnetic absorption profile and/or changes in the electromagnetic emission profile. In some embodiments, changes include changes in wavelength, intensity of absorption, intensity of emission, and/or combinations thereof. In some embodiments, the method detects changes in the concentration of the analyte in the fluid.

In some embodiments, the matrix material of the composite material is permeable to the analyte. In some embodiments, the matrix material of the composite material is selectively permeable to the analyte. In one aspect, the matrix material of the composite material is non-degrading to the TTz compound. In some embodiments, the analyte does not dissolve the matrix material of the composite material.

The analyte employed may be any analyte suitable for use in sensing methods. In some embodiments, the analyte can be a solvent. In some embodiments, the analyte is a volatile organic solvent. Non-limiting examples of analytes suitable for use in the methods of sensing herein include those described in Section II above.

Any fluid suitable for sensing methods may be used. In some embodiments herein, the fluid comprises a liquid. In other embodiments, the fluid comprises a gas. In some embodiments, the fluid is air or ambient atmosphere.

Novel and inventive composite materials as described in Section I above can also be applied in thermochromic applications. As such, in another aspect, a method of sensing employing a composite material as described herein may detect a temperature change.

In some embodiments, for example, a method of detecting a temperature change comprises providing a composite material as described herein, exposing the composite material to a first temperature, exposing the composite material to a second temperature, and detecting a change from the first temperature to the second temperature. In embodiments herein, the second temperature is different from the first temperature.

### EXAMPLES

The above and other embodiments are further illustrated in the following examples. It is to be understood that the examples herein are non-limiting, and are merely illustrative of principles of the present invention.

TTz-polymer composite materials were prepared by suspending various TTz compounds in polystyrene-block-polyisoprene-block-polystyrene (SIS) copolymers, and spin casting onto glass substrates. The thin films produced were used to detect volatile organic solvents (66 ppm) when exposed to vapors, while monitoring their change in fluorescence. Photophysical properties and solvatofluorochromic behavior were analyzed with Lippert-Mataga plots to derive the transition dipole moments (Au) of the exemplary materials. Solvatothermochromic properties were observed and quantified across a wide range of temperatures.

### Testing Methodology

4-nitrobenzaldehyde, 4-(dibutylamino)benzaldehyde, 4-(diphenylamino)benzaldehyde, 4-acetamidobenzladehyde, dithiooxamide, tetrabutylammonium hexafluorophosphate (TBAH) and all solvents used for spectroscopic measurements were purchased from Sigma-Aldrich and used without further purification. ¹H and ¹³C nuclear magnetic resonance (NMR) measurements were obtained with either a JEOL 300 MHz NMR or a JEOL 500 MHz NMR spectrometer. High resolution mass spectra were obtained using a Voyager Matrix Assisted Laser Desorption/Ionization Time-of-Flight (MALDI-TOF) mass spectrometer, using Anthracene-1,8,9-triol as a matrix. Solution-state UV-Vis (ultraviolet-visible) spectra were collected on a Cary 300 UV-Vis spectrophotometer. Time-resolved fluorescence lifetime measurements (time-correlated single-photon counting (TCSPC)) were taken on a Jobin Yvon-Spex Fluorolog equipped with a 389 nm diode laser for time-resolved photoluminescence (PL) decay measurements. All decays were calculated with a χ²≤1.2. Igor Pro 6.3 software was used to fit PL(t) decay data to single/multiple exponential decays. Quantum yields were calculated using perylene orange, perylene, and 9,10-diphenylanthracene as references (quantum yield [Φ_{F}] in chloroform=0.99±0.05, [Φ_{F}] in cyclohexane=0.94, and [Φ_{F}] in cyclohexane=0.90, respectively). Temperature studies were conducted using a 10 μM Bu₂N-TTz-NO₂ toluene solution placed inside of a Norrell 502 NMR tube, and sequentially submerged in the following liquid N₂ baths:octanol (−16° C.), acetonitrile (−41° C.), acetone (−94° C.), chloroform (−63° C.) and liquid N₂ (−196° C.). Unless otherwise noted, all experiments were conducted at room temperature. Due to the condensation of atmospheric moisture during low-temperature testing, only the normalized emission intensities are reported.

### Testing Methodology

A Gamry Reference 600 potentiostat was used for cyclic voltammetry to obtain the redox potentials and reversibility of the TTz compounds. All solutions were purged with argon. Platinum working, platinum foil counter, and Ag/AgNO₃ reference electrodes were used with ferrocene (fc) as an internal standard. Each TTz compound was dissolved into a 0.1 M TBAH 4 mL solution of dimethyl carbonate (DCM) until an adequate signal was observed. Scan rates of 50, 100, 150, 200, 250, 300, 400, and 500 mV s⁻¹ were used, and Fc was used at the end. The DCM was removed, and the solid was dissolved in toluene to determine concentrations using molar absorptivity. The diffusion coefficient was determined using the Randles-Sevcik Equation.

Organic vapor sensing studies (using a fixed volume) were conducted using 0.45 mM Ph₂N-TTz-NO₂ and Ph₂N-TTz-Py in toluene for SIS copolymers. A density of 100 mg/mL of SIS (20% styrene by wt.) was used, and 100 μL of each were spin cast (500 rpm) onto glass microscope slides. Emission was measured in a glass cuvette chamber before, during, and after exposure. 100 μL of each solvent was used, and the ppm was calculated using the ideal gas law (PV=nRT) from the vapor pressure of the solvent (at 25° C.) and the volume of the chamber (23.3 mL). Each spin cast polymer was cycled on and off by repeat exposures of the solvent to the slide. The chamber was dried upon each cycle with nitrogen gas. Total exposure to solvent each cycle was 1.5 min, with 3 min of aerated drying time in between each measurement. For emission scans, Ph₂N-TTz-NO₂ was excited at 445 nm, and Ph₂N-TTz-Py was excited at 400 nm. A single polymer/dye composite prepped slide was used for an entire iteration, where the slide was exposed to increasing concentrations of solvents with the ppm calculated from the vapor pressure. A lower detection limit for THF was determined using a larger volume flask (4.5 L) and longer exposure time (5 min) to THF solvent vapors.

In order to determine the absolute solid state fluorescence quantum yield, samples were drop-cast on precleaned silicon substrates and illuminated in an integrating sphere using a 400 nm, 10 mW laser to collect fluorescence quantum yield in the solid state. Light intensities scattered within the sphere were measured using Ocean optics spectrometer (QE65000). Fluorescence quantum yields were calculated using the equation:

$$Φ PL = \frac{α \int \frac{λ}{hc} [ {I}^{′} em ( λ ) - Iem ( λ ) ] d λ}{α \int \frac{λ}{hc} [ Iex ( λ ) - {I}^{′} ex ( λ ) ] d λ}$$

wherein α is the calibration factor for the instrument, λ is the wavelength, h is Plank's constant and c is the speed of light. Laser excitation intensity by blank silicon substrate is denoted by Iex(λ) and excitation intensity due to drop cast organic samples is denoted by I'ex(λ). The difference in excitation intensity represents the photons absorbed by the organic samples. Light scattering by blank silicon substrate in a wavelength range 425 nm to 790 nm is denoted by Iem(λ), while I'em(λ) represents the emission of organic samples. Tris(8-quinolinolato)aluminum (III) complex (Alq3) was used as a reference to test the accuracy of the method. Fluorescence quantum yield was measured to be 19±0.2%.

Solid-state compact film fluorescence and solvent vapor sensing were conducted by drop casting a saturated solution of Ph₂N-TTz-Py or Ph₂N-TTz-NO₂ on a precleaned microscope slide to form a crystalline film. Slides were exposed to DCM solvent vapors (7 ppm) for 2 min before acquiring fluorescence spectra. Slides were dried on a hot plate (70° C., 2 min) while the solvent chamber was dried using a stream of nitrogen to recover the pre-solvent vapor exposure emission of the films.

### Preparation of Exemplary TTz Compounds

### (A) 2-(N,N-dibutyl-4-aminophenyl)-5-(4-nitrophenyl) thiazolo[5,4-d]thiazole (Bu₂N-TTz-NO₂)

Dithiooxamide (0.2883 g, 2.399 mmol), 4-(diphenylamino)benzaldehyde (1.9975 g, 8.566 mmol), and 4-nitrobenzaldehyde (0.3079 g, 2.037 mmol) were mixed in 18 mL of dimethylformamide (DMF) and heated to 140° C. for 6 h in an aerated environment. The reaction was cooled to room temperature and left to sit in a fridge for 24 h. The solution was vacuum filtered, rinsed with water, and dried under a vacuum to produce a brownish solid (0.3190 g). Using an eluent of hexanes:ethyl acetate of 6:1, 13.8 mg of the crude product was purified by silica gel column chromatography (Silica Flash M60). The eluent was removed under vacuum, yielding a brown solid (4.0 mg, 29.0% recovery yield) giving an overall 9.7% yield. ¹H NMR (300 MHz, d-CDCl₃, δ): 8.32 (d, J=8.8 Hz, 2H), 8.13 (d, J=8.8 Hz, 2H), 7.83 (d, J=8.8 Hz, 2H), 6.67 (d, J=8.8 Hz, 2H), 3.35 (t, J=7.9 Hz, 4H), 1.61 (p, J=7.6 Hz, 4H), 1.38 (h, J=7.6 Hz), 0.98 (t, J=7.6 Hz, 6H). ¹³C NMR (126 MHz, CDCl₃, δ): 172.51, 163.13, 152.61, 150.52, 150.23, 148.27, 139.89, 128.30, 126.56, 124.53, 120.52, 111.38, 50.89, 29.47, 20.39, 14.06. UV-Vis λₘₐₓ (CHCl₃, M⁻¹ cm⁻¹): 462 nm (ε=19,900). MALDI-TOF-MS: m/z calculated for C₂₄H₂₆N₄O₂S₂ 466.618, found 466.601.

### (B) 2-(N,N-diphenyl-4-aminophenyl)-5-(4-nitrophenyl) thiazolo[5,4-d]thiazole (Ph₂N-TTz-NO₂)

4-nitrophenylbenzaldehyde (0.3079 g, 2.039 mmol), dithiooxamide (0.3028 g, 2.523 mmol), and 4-(diphenylamino)benzaldehyde (2.3984 g, 8.785 mmol) were mixed in 18 mL of DMF for 6 h at 140° C. in an aerated environment. The reaction was cooled to room temperature, and left to sit overnight. A red-orange precipitate was collected via vacuum filtration and rinsed with water (0.3696 g). Using an eluent of DCM:hexanes of 2:1, 15.9 mg of the crude product was purified by silica gel column chromatography (Silica Flash M60). The eluent was removed under vacuum, yielding a red solid (9.3 mg, 58.5% recovery yield) giving an overall 20.9% yield. ¹H NMR (500 MHz, d-CDCl₃, δ): 8.33 (d, J=8.9 Hz, 2H), 8.15 (d, J=8.9 Hz, 2H), 7.83 (d, J=8.9 Hz, 2H), 7.32 (t, J=8.9 Hz, 4H), 7.17 (d, J=8.9 Hz, 4H), 7.13 (t, J=8.9 Hz, 2H), 7.08 (d, J=8.9 Hz, 2H). ¹³C NMR (126 MHz, CDCl₃, δ): 171.12, 164.45, 152.45, 151.06, 150.70, 148.55, 146.77, 139.62, 129.68, 127.70, 126.80, 125.70, 124.56, 124.43, 124.09, 121.50. UV-Vis λₘₐₓ (CHCl₃, M⁻¹ cm⁻¹): 446 nm (ε=11,400). MALDI-TOF-MS: m/z calculated for C₂₈H₁₈N₄O₂S₂ 506.598, found 506.570.

### (C) 2-(4-acetoaminophenyl)-5-(4-nitrophenyl) thiazolo[5,4-d]thiazole (AcHN-TTz-NO₂)

4-nitrophenylbenzaldehyde (0.600 g, 3.97 mmol), 4-acetamidobenzaldehyde (0.648 g, 3.97 mmol), and dithiooxamide (0.477 g. 3.97 mmol), were mixed in 70 mL anhydrous DMF for 6 h at 140° C. The reaction mixture was cooled to room temperature and left overnight, whereby a yellow-orange solid precipitated out of solution. The precipitate was collected via vacuum filtration and rinsed with water (0.6808 g). Using an eluent of CHCl₃:ethyl acetate of 1:1, (1% triethylamine), 50.1 mg of the precipitate was purified by silica gel column chromatography (Silica Flash M60). A yellow solid (29.3 mg, 58.5% recovery yield) was collected after chromatographic separation giving an overall 25.3% yield. ¹H NMR (300 MHz, d-DMSO, δ): 10.25 (s, 1H), 8.35 (d, J=9.2, 2H), 8.25 (d, J=9.1 Hz, 2H), 7.97 (d, J=8.7 Hz, 2H), 7.75 (d, J=8.8 Hz, 2H), 2.06 (s, 2H). ¹³C NMR (126 MHz, DMSO): 170.71, 169.48, 165.50, 152.34, 151.02, 148.82, 142.87, 139.10, 127.90, 127.81, 127.66, 125.27, 119.71, 24.71. UV-Vis λₘₐₓ (CHCl₃, M⁻¹ cm⁻¹): 400 nm (ε=44,500).

### (D) 2-(4-aminophenyl)-5-(4-nitrophenyl) thiazolo[5,4-d]thiazole (H₂N-TTz-NO₂)

AcNH-TTz-NO₂ (0.0530 g, 0.134 mmol) and 4 mL of concentrated HCl were refluxed in 16 mL of n-butanol for 48 h. The reaction was cooled to room temperature, vacuum filtered, and rinsed with hexanes. The crude red product was resuspended in a 0.1 M NaOH solution and heated to 70° C. for 1 h. The solution was then vacuum filtered, rinsed with water, and dried under reduced pressure to give a red/orange solid, 0.0185 g (39.4% yield). 1H NMR (300 MHz, DMSO, δ): 8.34 (d, J=9.2 Hz, 2H), 8.22 (d, J=9.2, 2H), 7.70 (d, J=8.6 Hz, 2H), 6.64 (d, J=8.7 Hz, 2H), 5.99 (s, 2H). ¹³C NMR (126 MHz, DMSO): 172.50, 163.62, 153.17, 152.38, 149.69, 148.53, 139.36, 128.66, 127.31, 125.30, 125.24, 120.63, 114.21. UV-vis λₘₐₓ (CHCl₃, ε=M⁻¹ cm⁻¹): 409 nm (ε=12,600) MALDI-TOF-MS: calcd for C₁₆H₁₀N₄O₂S₂: 354.402; found, 354.536.

### (E) Bis-(4-acetamidophenyl)-thiazolo[5,4-d]thiazole ((AcNH)₂TTz)

Dithiooxamide (0.9263 g, 7.707 mmol) and 4-acetamidobenzaldehyde (3.1894 g, 19.546 mmol) were heated in 40 mL of DMF at 140° C. for 8 h in an aerated environment. The reaction was cooled to room temperature and left to sit in a fridge overnight. The solution was then vacuum filtered and rinsed with cooled ether and hexanes. The solid was dried in a vacuum oven and gave a bright yellow solid (1.2082 g, 38.9% yield). ¹H-NMR (300 MHz, d-DMSO), δ 10.20 (s, 2H), 7.92 (d, J=8.7 Hz, 4H), 7.72 (d, J=8.7 Hz, 4H), 2.05 (s, 6H) ppm. ¹³C NMR (126 MHz, DMSO): 169.30, 168.60, 150.20, 142.41, 128.23, 127.46, 119.72. UV-vis λₘₐₓ (CHCl₃, ε=M⁻¹ cm⁻¹): 380 nm (ε=14,100) MALDI-TOF-MS: calcd for C₂₀H₁₆N₄O₂S₂ 408.494; found, 408.517. Φ_{CHCl}_{₃}=0.367.

### (F) Bis-(4-aminophenyl)-thiazolo[5,4-d]thiazole ((H₂N)₂TTz)

(AcNH) 2TTz (0.5058 g, 1.572 mmol) was added to 165.5 mL of n-butanol and 33.75 mL concentrated HCl, and heated to 100° C. for 96 h. The solution was vacuum filtered and rinsed with hexanes. The solid was dried via vacuum oven, dissolved in 0.1 M NaOH, and heated to 50° C. for 1 h. The solution was then vacuum filtered and rinsed with water. The product was vacuum dried and placed in a Schlenk tube where it was sublimed under vacuum overnight at 250° C. The product on the cold finger was collected to give a bright yellow solid (365.1 mg, 90.9% yield). ¹H-NMR (300 MHz, d-ACN), δ 7.70 (d, J=8.9 Hz, 4H), 6.69 (d, J=8.9 Hz, 4H), 4.62 (s, 4H) ppm. UV-vis λₘₐₓ (CHCl₃, ε=M⁻¹ cm⁻¹): 389 nm (ε=72,600) MALDI-TOF-MS: calcd for C₁₆H₁₂N₄S₂ 324.050; found, 324.955. Φ_{CHCl3}=0.193.

### Preparation of Composite Materials

Exemplary TTz compounds as described above were synthesized at the conditions described above. Dye purification was accomplished using column chromatography with 20.9-58.5% recovery, and overall yields from 9.7-25.3%.

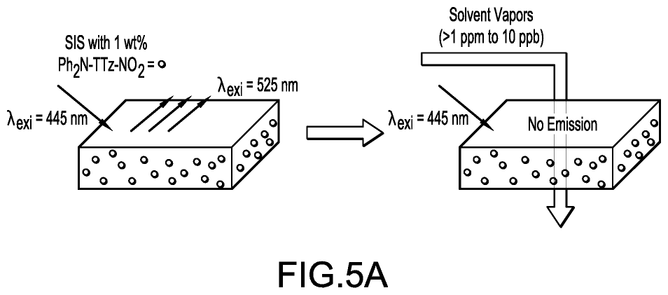

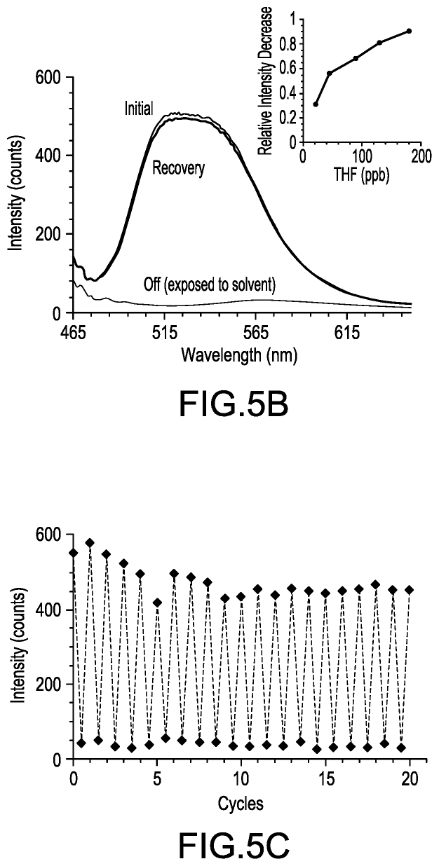

TTz-polymer composites were prepared by suspending the various TTz compounds as described above in polystyrene-block-polyisoprene-block-polystyrene (SIS) copolymers, and spin casting onto glass substrates. Specifically, exemplary TTz-polymer composites were prepared by embedding exemplary TTz compounds as described above in styrene-isoprene-styrene (SIS) block copolymers. FIG. 5A shows a fluorescent film on a glass of TTz (1 wt. % Ph₂N-TTz-NO₂) embedded in a SIS polymer, and exposure to organic solvent vapors to quench the fluorescence. The chosen SIS polymer materials have low cost, commercial availability, thermoplastic elastomer characteristics, and excellent processability, and can be sprayed on or hot-melted to form adhesive layers. Composite materials and optical vapor sensing platforms were developed by dissolving ˜1 wt. % of the TTz compounds and SIS block copolymers into toluene, and spin-casting onto glass slides, to produce highly fluorescent thin polymer films.

### Results

The absorbance (Abs), emission (Em), fluorescence, molar absorptivity (ε), fluorescence quantum yield (QY), and fluorescence lifetimes of the exemplary TTzs compounds were obtained in various organic solvents, and are shown in Table 1 below.

TABLE 1
Optical Properties of Amino/Nitrophenyl TTz Compounds in Various Solvents

| | | | | | | | | | | | Non- |
|---|---|---|---|---|---|---|---|---|---|---|---|
| | | | | | | | Stokes | | Fluorescence | | radiative |
| | | Abs | Abs | Ext. coeff. | Em | Em | Shift | | Lifetime | Radiative rate | rate |
| | | (nm) | (eV) | (M · cm)⁻¹ | (nm) | (eV) | (eV) | % QY | (ns) | (sec⁻¹) | (sec⁻¹) |
| Dye | solvent | λₘₐₓ | Eₑₓ | ε | λₘₐₓ | Eₑₘ | SS | Φ_{F} | τ_{F} | kᵣ | kₙᵣ |
| Bu₂N- | Hex | 447 | 2.77 | 13000 | 499 | 2.48 | 0.29 | 53.5 | 2.18 | 2.45 × 10⁸ | 2.13 × 10⁸ |
| TTz- | Tol | 458 | 2.71 | 24300 | 561 | 2.21 | 0.50 | 42.2 | 2.74 | 1.55 × 10⁸ | 2.10 × 10⁸ |
| NO₂ | Bz | 458 | 2.71 | 31800 | 563 | 2.20 | 0.51 | 39.5 | 2.62 | 1.51 × 10⁸ | 2.31 × 10⁸ |
| | Cl-Bz | 467 | 2.66 | 17700 | 614 | 2.02 | 0.64 | 0.8 | 1.41 | 5.62 × 10⁶ | 7.04 × 10⁸ |
| | THF | 456 | 2.72 | 22300 | 504 | 2.47 | 0.25 | 0.6 | 1.83 | 3.28 × 10⁶ | 5.43 × 10⁸ |
| | Bz-CN | 469 | 2.64 | 20220 | 518 | 2.39 | 0.25 | 0.2 | 1.22 | 1.64 × 10⁶ | 8.18 × 10⁸ |
| | CHCl₃ | 462 | 2.68 | 19900 | 487 | 2.55 | 0.13 | 3.1 | 1.14 | 2.72 × 10⁷ | 8.50 × 10⁸ |
| | EtOH | 437 | 2.84 | 2200 | 488 | 2.54 | 0.30 | 6.4 | 1.34 | 4.78 × 10⁷ | 6.99 × 10⁸ |
| Ph₂N- | Hex | 438 | 2.83 | 11100 | 489 | 2.54 | 0.29 | 69.2 | 2.26 | 1.36 × 10⁸ | 3.06 × 10⁸ |
| TTz- | Tol | 444 | 2.79 | 46900 | 547 | 2.27 | 0.52 | 63.1 | 2.87 | 1.89 × 10⁸ | 1.60 × 10⁸ |
| NO₂ | Bz | 447 | 2.77 | 19300 | 550 | 2.25 | 0.52 | 56.8 | 2.69 | 2.11 × 10⁸ | 1.61 × 10⁸ |
| | Cl-Bz | 453 | 2.74 | 45500 | 592 | 2.09 | 0.65 | 2.9 | 1.78 | 1.63 × 10⁷ | 5.46 × 10⁸ |
| | THF | 444 | 2.79 | 11700 | 497 | 2.49 | 0.30 | 0.6 | 1.69 | 3.55 × 10⁶ | 5.88 × 10⁸ |
| | Bz-CN | 447 | 2.77 | 58600 | 501 | 2.48 | 0.29 | 0.4 | 1.78 | 2.25 × 10⁶ | 5.60 × 10⁸ |
| | CHCl₃ | 446 | 2.78 | 11400 | 487 | 2.55 | 0.23 | 5.0 | 1.37 | 3.65 × 10⁷ | 6.93 × 10⁸ |
| | EtOH | 436 | 2.84 | 3000 | 499 | 2.48 | 0.36 | 13.1 | 1.27 | 1.03 × 10⁸ | 6.84 × 10⁸ |
| AcNH- | Tol | 398 | 3.12 | 21000 | 490 | 2.53 | 0.59 | 9.3 | 1.48 | 6.38 × 10⁷ | 6.13 × 10⁸ |
| TTz- | Bz | 398 | 3.12 | 26000 | 493 | 2.52 | 0.60 | 10.9 | 1.05 | 1.04 × 10⁸ | 8.49 × 10⁸ |
| NO₂ | Cl-Bz | 402 | 3.08 | 7000 | 526 | 2.36 | 0.72 | 22.1 | 2.32 | 9.53 × 10⁷ | 3.36 × 10⁸ |
| | THF | 397 | 3.12 | 33900 | 533 | 2.33 | 0.79 | 17.9 | 1.89 | 9.47 × 10⁷ | 4.34 × 10⁸ |
| | Bz-CN | 404 | 3.07 | 14300 | 461 | 2.70 | 0.37 | 4.9 | 1.27 | 3.86 × 10⁷ | 7.49 × 10⁸ |
| | | | | | (558) | (2.22) | (0.85) | | | | |
| | CHCl₃ | 400 | 3.10 | 44500 | 557 | 2.23 | 0.87 | 8.5 | 1.72 | 4.94 × 10⁷ | 5.32 × 10⁸ |
| H₂N- | Tol | 408 | 3.04 | 17000 | 544 | 2.28 | 0.76 | 1.8 | 2.51 | 7.17 × 10⁶ | 1.63 × 10⁸ |
| TTz- | Bz | 408 | 3.04 | 9000 | 544 | 2.28 | 0.76 | 2.7 | 2.15 | 1.26 × 10⁷ | 4.53 × 10⁸ |
| NO₂ | Cl-Bz | 412 | 3.01 | 31000 | 507 | 2.45 | 0.56 | 2.1 | 1.66 | 1.29 × 10⁷ | 5.90 × 10⁸ |
| | THF | 407 | 3.05 | 14700 | 508 | 2.44 | 0.61 | 1.1 | 1.42 | 7.76 × 10⁶ | 6.96 × 10⁸ |
| | Bz-CN | 412 | 3.01 | 9900 | 509 | 2.44 | 0.66 | 2.2 | 1.79 | 1.23 × 10⁷ | 5.43 × 10⁸ |
| | CHCl₃ | 409 | 3.03 | 12600 | 529 | 2.34 | 0.69 | 1.5 | 2.07 | 7.25 × 10⁶ | 4.76 × 10⁸ |

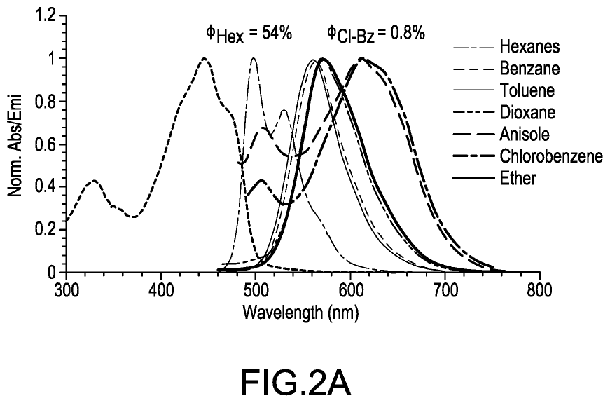

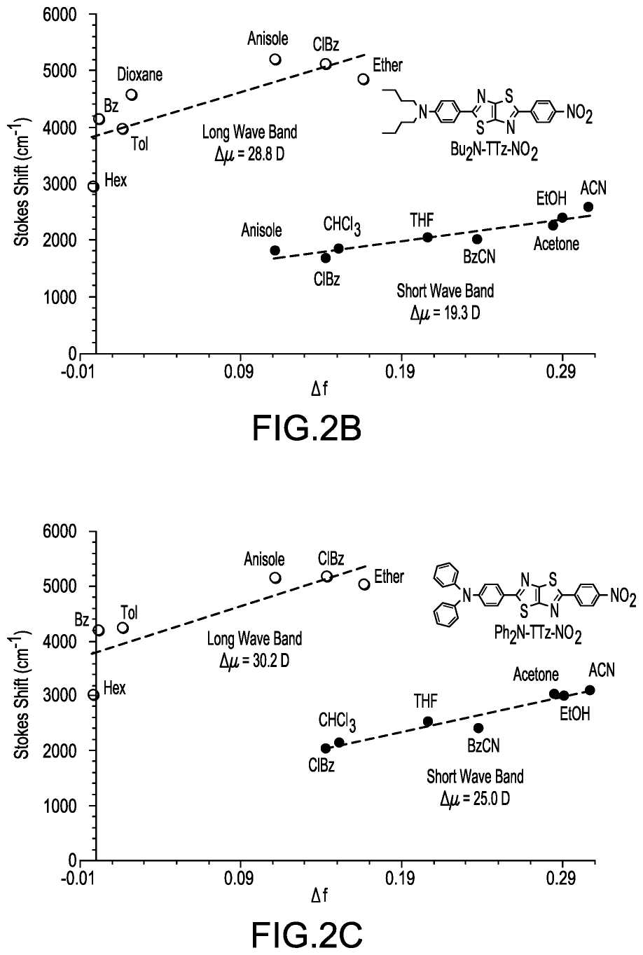

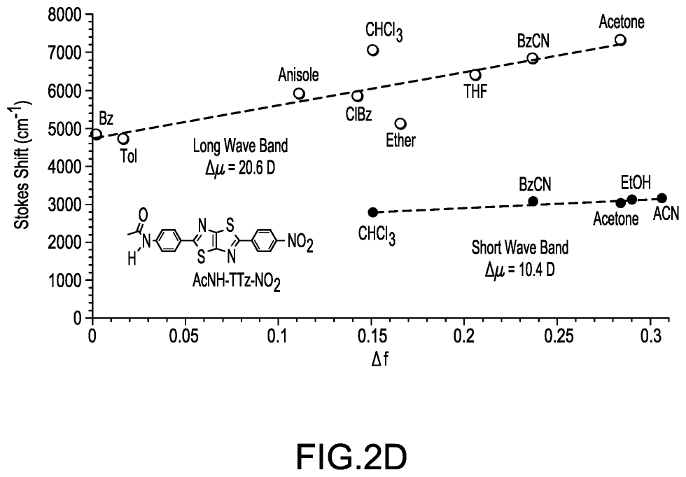

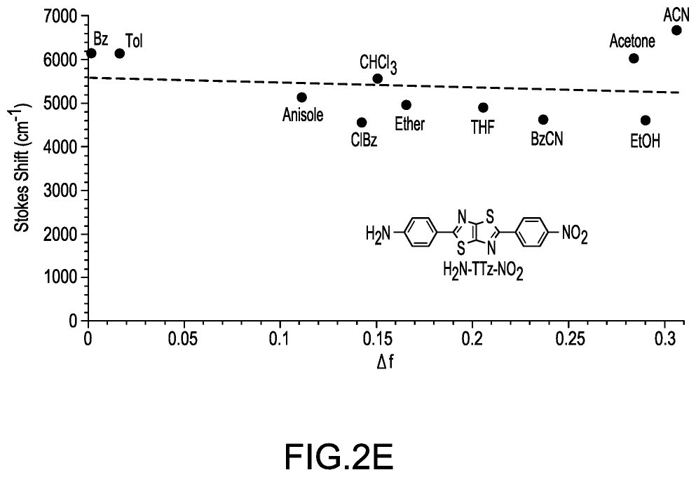

FIG. 2A shows the absorbance of Bu₂N-TTz-NO₂ in hexane, and emission in several solvents. Emissions were obtained with excitation of the absorbance max of the respective solvent. FIGS. 2B and 2C show the Lippert-Mataga plots of Bu₂N-TTz-NO₂ and Ph₂N-TTz-NO₂, respectively. Additionally, FIGS. 2D and 2E show the Lippert-Mataga plots of AcNH-TTz-NO₂ and H₂N-TTz-NO₂.

As shown in Table 1, the molar absorptivity (8) of the exemplary TTz compounds ranged from 7000-58600 M⁻¹ cm⁻¹. Bu₂N-TTz-NO₂ and Ph₂N-TTz-NO₂ exhibited an absorbance max (λ_{abs}) range of 436-462 nm in various solvents which are red shifted relative to AcNH-TTz-NO₂ and H₂N-TTz-NO₂. Without intending to be bound by theory, it is believed that the observed bathochromic shift between the TTz derivatives was likely due to an increase in donor strength of the dibutyl and diphenylamino groups, resulting in varying electron density across the system. For all solvents except ethanol, there was little variation of labs, indicating minimal solvent effects on the neutral ground state dipole moment. Not to be bound by theory, it is believed that the anomalous behavior of the absorbances in ethanol can be attributed to the presence of hydrogen bonding and solubility differences. Unlike other push-pull dyes, the Aabs values obtained have a narrow range (436-462 nm) compared to the broad range (487 nm-614 nm) of the emission. This demonstrates the charge transfer only in the excited state, which evidences that the exemplary composite materials described herein are solvatofluorochromic, as opposed to only solvatochromic. This behavior has also been confirmed computationally with other exemplary TTz compounds according to embodiments herein.

Cyclic voltammetry measurements were obtained to characterize redox behavior and calculate HOMO/LUMO levels. The obtained results are shown below in Tables 2-4.

TABLE 2
Current of forward and reverse peaks

| | | | Bu₂N-TTz- | AcNH-TTz- | H₂N-TTz- |
|---|---|---|---|---|---|
| | Ph₂N-TTz-NO₂ | | NO₂ | NO₂ | NO₂ |
| v | I_{pf} | Iₚᵣ | I_{pf} | I_{pf} | I_{pf} |
| (mV/s) | (μA) | (μA) | (μA) | (μA) | (μA) |
| 50 | 1.28 | −1.12 | 1.17 | 2.48 | 24.15 |
| 100 | 1.82 | −1.48 | 1.51 | 3.29 | 31.34 |
| 150 | 2.21 | −1.93 | 179 | 3.93 | 37.86 |
| 200 | 2.55 | −2.21 | 2.06 | 4.45 | 42.72 |
| 250 | 2.83 | −2.50 | 2.28 | 4.96 | 46.82 |
| 300 | 3.15 | −2.77 | 2.55 | 5.41 | 50.91 |
| 400 | 3.71 | −3.20 | 2.81 | 6.06 | 57.22 |
| 500 | 4.17 | −3.59 | 3.11 | 6.71 | 62.56 |

TABLE 3
Reversibility of Ph₂N-TTz-NO₂ from the ratio of I_{pf}/Iₚᵣ

| v | I_{pf}/Iₚᵣ |
|---|---|
| 50 | 1.14 |
| 100 | 1.23 |
| 150 | 1.14 |
| 200 | 1.15 |
| 250 | 1.14 |
| 300 | 1.14 |
| 400 | 1.16 |
| 500 | 1.16 |

TABLE 4
Redox potentials of exemplary TTz compounds

| | D (cm² s⁻¹) × | Eₒₓ vs | E_{red} vs | HOMO | LUMO |
|---|---|---|---|---|---|
| a-TTz | 10⁻⁵ | Fc (V) | Fc (V) | (eV) | (eV) |
| Ph₂N-TTz-NO₂ | 1.84 | 0.50 | −1.40 | −5.19 | −3.29 |
| Bu₂N-TTz-NO₂ | 0.24 | 0.45 | −1.41 | −5.14 | −3.28 |
| AcNH-TTz-NO₂ | — | 0.92 | −1.47 | −5.61 | −3.22 |
| H₂N-TTz-NO₂ | — | 0.96 | −1.45 | −5.65 | −3.24 |

The Ph₂N-TTz-NO₂ and Bu₂N-TTz-NO₂ TTz exemplary compounds exhibited strong solvatofluorochromism, with Stoke shifts between 0.13-0.65 eV. The compounds also exhibited high fluorescence quantum yields (QYs) in nonpolar solvents, and low QYs in polar solvents. For instance, as shown in FIG. 2A, for Ph₂N-TTz-NO₂: Φ_{Hex}=69%, Φ_{BzCN}=0.4%.

Decreasing QYs can occur in push-pull fluorophores with a strong ICT character in increasingly polar solvents. However, the effect in the experiments herein appears to have been magnified due to the presence of a nitrophenyl group, which appears to have favored intersystem crossing (ISC) to a non-radiative triplet state. For instance, a diphenylamino/pyridyl aTTz derivative (Ph₂N-TTz-Py) with no nitrophenyl substituents exhibited a QY in CHCl₃ of Φ_{F}=0.54, while a similar Ph₂N-TTz-NO₂ dye shows a quantum yield of Φ_{F}=0.05 in the same solvent.

Without being bound by theory, the increase in QY for Ph₂N-TTz-NO₂ and Bu₂N-TTz-NO₂ in ethanol is attributed to hydrogen bonding in the excited state. As shown in Table 1, AcNH-TTz-NO₂ achieved a QY between that of the symmetric TTzs (AcNH)₂TTz (Φ_{CHCl3}=0.37) and (NO₂)₂TTz (Φ_{CHCl3}<0.01).

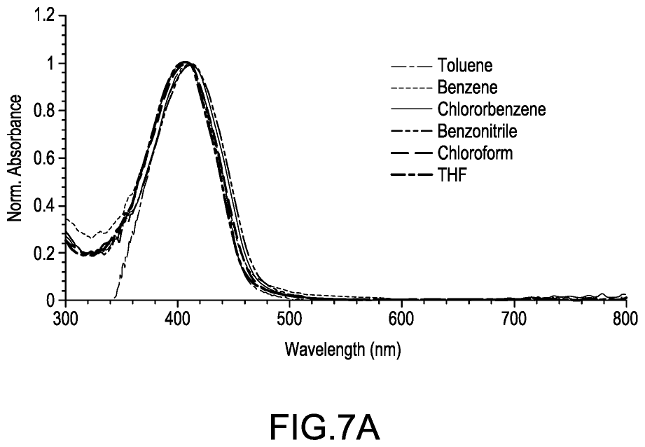

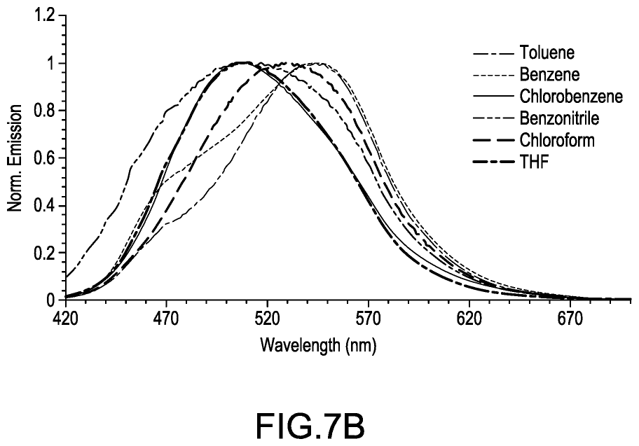

As shown in FIG. 7B, H₂N-TTz-NO₂ exhibited a broad range of emission, with onsets from 420 nm to 650 nm, demonstrating the presence of a strong ICT state with low QYs similar to fluorophores containing alkyne or triphenyl π-bridges. FIG. 7A shows the absorbance of H₂N-TTz-NO₂ in various solvents.

As shown in Table 1, fluorescence lifetimes (τ_{F}) in various solvents showed an increase when increasing the polarity from hexane to toluene (Bu₂N-TTz-NO₂ τ_{F}=2.18 to 2.74 ns and Ph₂N-TTz-NO₂ τ_{F}=2.26 to 2.87 ns). This is representative behavior for increasing ICT character in the excited state. However, beyond this solvent polarity, the n becomes shorter as the ICT state is almost completely quenched by the nitrophenyl group. The non-radiative rate (Bu₂N-TTz-NO₂, k_{nr CHCl3}=8.50×10⁸ s⁻¹) was therefore faster than the radiative rate (k_{r CHCl3}=2.72×10⁷ s⁻¹) in more polar solvents.

As shown in FIG. 1C, the exemplary TTz compounds described above were deemed highly planar. These compounds favored electron density on the nitrophenyl groups in the ICT excited state, resulting in a strong push-pull solvatofluorochromic effect. For instance, the fluorescence of Bu₂N-TTz-NO₂ was red-shifted 115 nm (λₑₘᵢ) (Bu₂N-TTz-NO₂, λ_{emi hex}=499 to λ_{emi CIBz} 614 nm). To quantify this, the fluorescence emission intensities of the compounds were evaluated in a variety of solvents with a range of polarities, and their Stokes shifts were used to evaluate the compounds' excited-state dipole behaviors.

Another feature which was observed in the emission spectra for several polar solvents (e.g. chlorobenzene, anisole) was the presence of two bands, specifically a short wavelength band (SWB˜500 nm) and a long wavelength band (LWB˜625 nm). FIG. 2A shows this phenomenon. Previous studies on amino-nitro push-pull dyes have associated multiple band, dual fluorescence to a twisted ICT (TICT) state and a locally excited (LE) state. Compared to initial studies of aTTz compounds (i.e., asymmetric TTz compounds), the SWB values obtained were considerably more visible due to strong quenching of the ICT (LWB) state by the nitrophenyl group in polar media. Only the LE (SWB) was observable in strongly polar solvents (CHCl₃ and benzonitrile, which gives the appearance of a blue-shifted solvatofluorochromism. To confirm the presence of the ICT state, a strong acid (trifluoroacetic acid (TFA)) was used to protonate each aTTz derivative, limiting the shift of electron density, and increasing polarity in the excited state. Due to the dual solvatofluorochromic effect in Bu₂N-TTz-NO₂ and Ph₂N-TTz-NO₂, the excited-state dipole moments were calculated separately for the SWB and LWB bands using the Lippert-Mataga (LM) equation:

$${v}_{a} - {v}_{f} = \frac{2 {( {μ}^{*} - μ )}^{2}}{4 {πϵ}_{0} {hca}^{3}} Δ f + const . ; Δ f = ( \frac{ε - 1}{2 ε + 1} - \frac{{η}^{2} - 1}{2 {η}^{2} + 1} )$$

wherein νₐ and ν_{f} are the absorption and emission peaks in cm⁻¹, μ* and μ are the excited state and ground state dipoles, ϵ₀ is the vacuum permittivity, h is Planck's constant, c is the speed of light, a is the Onsager cavity radius, Δf is the orientation polarizability, ε is the relative permittivity, and n is the refractive index. The ground state dipole and Onsager cavity radius were calculated using Gaussian software. The 4πϵ₀ constant comes from the reaction field factor. The obtained values are shown in Table 5.

TABLE 5
Ground and Excited State Dipole Moments

| | Onsager | Ground | Excited | Change |
|---|---|---|---|---|
| | Cavity Radius | State Dipole | State Dipole | in Dipole |
| Compound | α (Å)^{a} | μ (D)^{a} | μ* (D)^{b} | Δμ (D)^{b} |
| Bu₂N-TTz- | 7.88 | 12.3 | 32.7 | 20.4 |
| NO₂ (LWB) | | | | |
| Bu₂N-TTz- | 7.88 | 12.3 | 25.9 | 13.6 |
| NO₂ (SWB) | | | | |
| Ph₂N-TTz- | 7.88 | 9.26 | 30.6 | 21.3 |
| NO₂ (LWB) | | | | |
| Ph₂N-TTz- | 7.88 | 9.26 | 26.9 | 17.7 |
| NO₂ (SWB) | | | | |
| AcNH-TTz- | 7.87 | 9.23 | 29.8 | 20.6 |
| NO₂ (LWB) | | | | |
| AcNH-TTz- | 7.87 | 9.23 | 19.7 | 10.4 |
| NO₂ (SWB) | | | | |

^{a}Calculated using DFT PBEIPBE/6-311G + (d, p) with tight SCF, fine grid integral, and volume keyword
^{b}Semi-empirically calculated using the Lippert-Mataga Equation
^{a,b}The small change in absorbance results in a small change in μ when the aTTzs are dissolved in various solvents. Therefore, the calculated μ is sufficient for Δμ and μ*

The data in Table 5 shows that the transition state dipole moments (Δμ of the LWB) of the exemplary TTz compounds herein (Δμ=20.4-21.3 D) are larger than previous aTTz materials, and comparable to some of the largest push-pull dyes reported, including fluorene-based Prodan derivatives (Δμ=14 D), ladder-type dyes (Δμ=19 D), flavonoid dyes (Δμ=15.4 D), and aryl-hydroxychromones (Δμ=15 D).

The exemplary TTz compounds described herein also exhibited a wide spectral Stokes shift range between 0.13-0.87 eV (1050-7020 cm⁻¹). Arylaminothiazole dyes have also shown strong Stokes shifts in CHCl₃ (˜5900 cm⁻¹), but smaller changes in spectral shift vs. solvent polarity result in a lowered Δμ=11 D. The exemplary aTTz materials described herein included a strongly quenching nitrophenyl substituent, resulting in an observable LE (SWB), which is unique among push-pull dyes. Therefore, the present inventors have experimentally been able to quantify, for the first time, the Δμ separately for both LWB and SWB excited-states associated with each exemplary TTz compound.

The LWB transition (Δμ=20-21 D) was considerably more polar than the SWB (Δμ=10-17 D) excited state. However, as shown in FIGS. 2B and 2C, LM fit analyses of the LWB showed a slightly lower degree of linearity. In addition, the LM plots do not account for solute-solvent specific interactions, nor the polarizability of the solutes, which likely impact the LWB/ICT photophysical dynamics.

Further insight into the large shift in excited-state dipole moments was obtained computationally. Excited states were modeled in Gaussian using a hybrid functional PBE0 (PBE1PBE) with a 6-311+G(d,p) basis set and integral equation formalism model (IEFPCM) for solvation. Initial optimization of the TTz derivatives in vacuum demonstrated the push-pull nature of the molecules, with HOMOs residing on the aminophenyl donating groups, and LUMOs on the nitrophenyl groups.

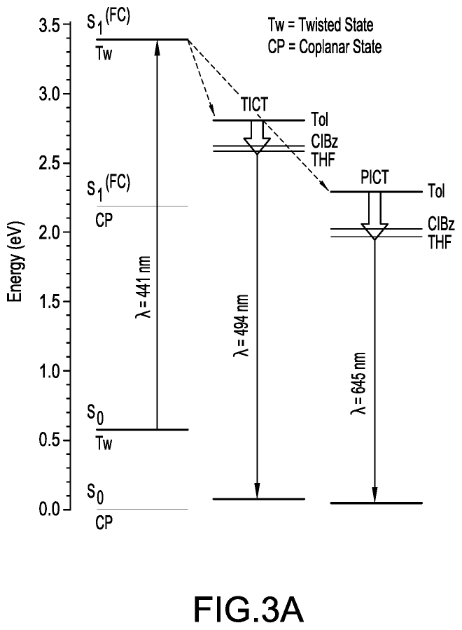

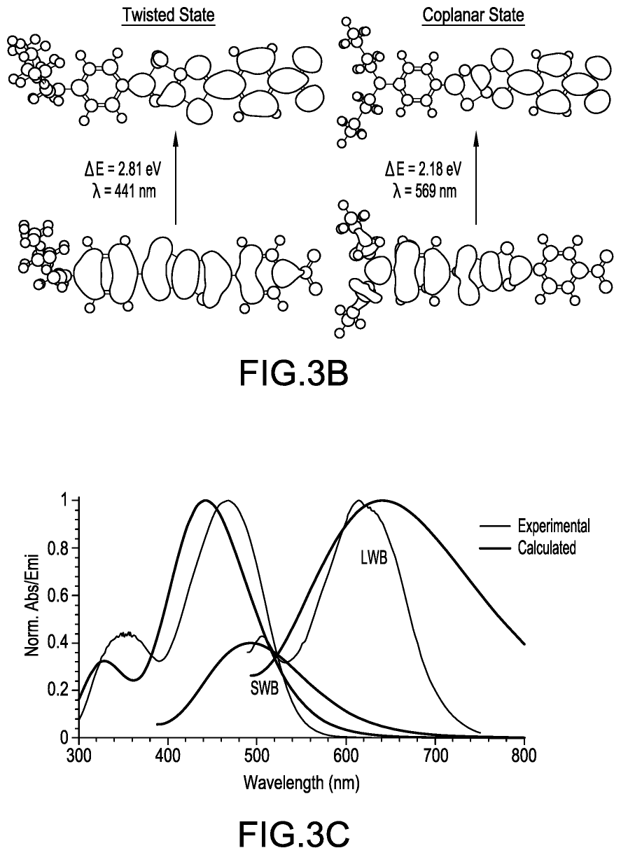

To observe both SWB and LWB bands, Bu₂N-TTz-NO₂ was modeled in chlorobenzene (ClBz). However, time dependent DFT (TDDFT) calculations did not properly reflect the experimental absorbance spectra. The potential for both a planarized and a twisted intramolecular charge transfer state (PLATICT) was explored due the possibility of a twisted amino-carbon phenyl bond in the excited state. Rotating and fixing the TTz amino-phenyl dihedral bond of Bu₂N-TTz-NO₂ to 90°, and modeling the absorbance spectra, provided a good fit of the experimental absorbance and emission spectra, which evidenced that the experimental TTz dyes were in a twisted ground state. FIG. 3B shows the HOMO and excited state (FC) MO's of the twisted and coplanar states.

The Franck-Condon excited states were found, and geometrically optimized to determine the excited state minima (ESM), and the emission spectrum was calculated. A twisted ESM was optimized by also holding in place the dihedral angles. The coplanar ESM most closely fit the LWB emission, while a twisted ESM fit the emission of the SWB. FIG. 3C shows the experimental and calculated spectra of Bu₂N-TTzNO₂ in THF. Therefore, the LWB was associated with a planar intramolecular charge transfer (PICT) state, while the SWB was associated with a twisted ICT (TICT) state. Bu₂N-TTz-NO₂ was also modeled in toluene, where only the PICT state was observed, and in THF, where only the TICT state was observed. A calculated bathochromic shift in emission was also observed, following the experimental solvatofluorochromic effects. FIG. 3A shows a modified relative energy Jablonski diagram, showing the ground state optimized coplanar and twisted state, the Franck-Condon excited states (in THF), the excited state minima's of the twisted (90°) and coplanar states in various solvents, and their ground state upon emission (in THF).

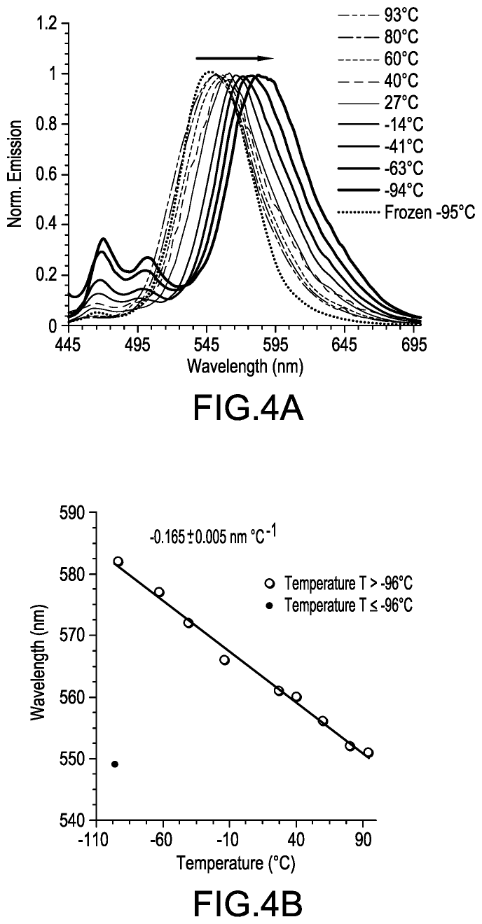

The solvatofluorochromism of the experimental TTz compounds herein was investigated in a Bu₂N-TTz-NO₂ thermofluorochromic application. Thermochromism is complementary to solvatofluorochromism, where the solvent polarity and, therefore, emission of a push-pull compound is dependent on temperature. The normalized fluorescence emissions of Bu₂N-TTz-NO₂ solutions in toluene were monitored from −94 to 94° C., as shown in FIG. 4B. Bu₂N-TTz-NO₂ was chosen due to its large Stokes shift, good solubility, and representative photophysical characteristics. Toluene was chosen due to its wide liquid temperature window (−94.9 to 110° C.) and ability to form a glass upon freezing. Bu₂N-TTz-NO₂ also exhibited a large QY in toluene and a single LWB (ICT) peak, which simplified monitoring changes in emission. Low temperature studies were achieved using various liquid N₂ cooling baths.

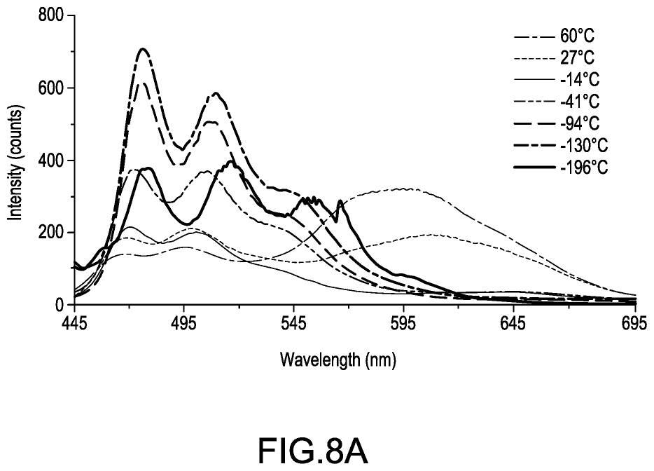

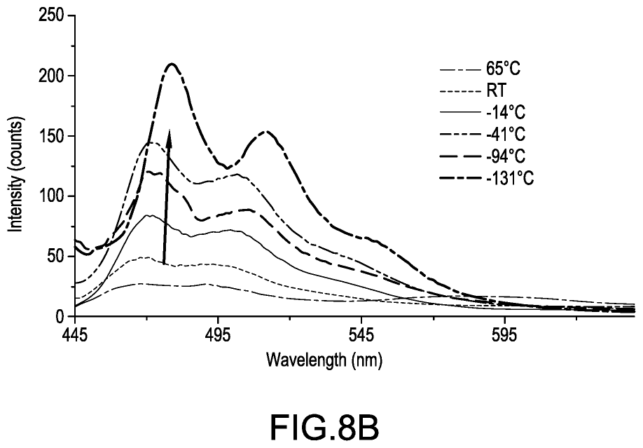

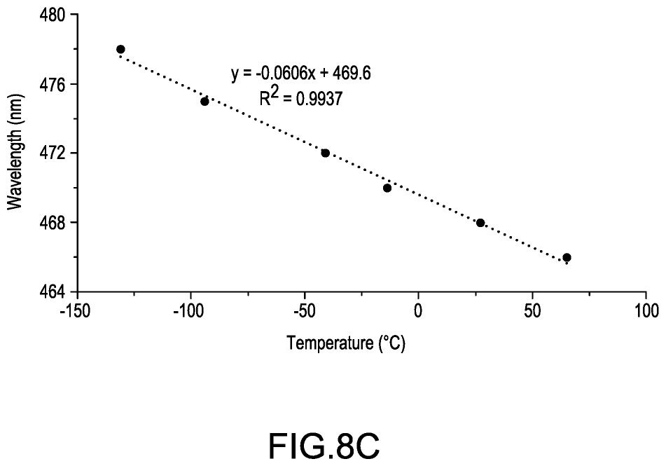

The emission of Bu₂N-TTz-NO₂ red shifted as the temperature decreased from 551 nm at 94° C. to 582 nm at −94° C., demonstrating a high linear temperature sensitivity (−0.17 nm ° C.⁻¹), confirming the suitability of the composite materials herein for a variety of temperature-sensing applications. Higher temperatures prevented alignment of solvent dipoles, leading to an observed blue-shift in the emission spectra of the experimental TTz compounds. FIG. 4A shows the normalized emission intensity spectra of Bu₂N-TTz-NO₂. As shown in FIG. 4A, appearance and strengthening of the SWB (TICT) emission (450-500 nm) were observed as the temperature decreased from −14 to −94° C. Upon freezing the solvent (<−94° C.), a hypsochromic emission shift (to ˜550 nm) was observed, which is attributed to the complete inhibition of solvent relaxation. In highly polar solvents like Me-THF, less sensitivity to temperature was observed (−0.06 nm ° C.⁻¹), as shown in FIG. 8B and FIG. 8C. A strong excimer emission was also observed as a broad peak, around 620 nm at 80 μM, as shown in FIG. 8A. Upon cooling or dilution, the intensity of the excimer emission was reduced, as shown in FIG. 8B.

The solid-state sensing performance of composite materials prepared in accordance with some embodiments herein was evaluated by embedding the Ph₂N-TTz-NO₂ derivatives described above in a block copolymer for organic solvent vapor sensing. Fluorescent dyes have shown sensitivity to organic vapors by relying on aggregation-induced emission through polymer swelling, fluorescence changes of molecular solids on filter paper, in nanomaterials, or in printed arrays. Some advantages of using Ph₂N-TTz-NO₂ in a polymer vapor sensor were confirmed in terms of the dual properties of solvatofluorochromism, believed to be due to the strong excited-state dipole change, and fluorescence quenching via ICS induced by the nitrophenyl group under exposure to polar solvent vapors.

The evaluated fluorescence of the composite films showed emission spectra which indicated that the polymer environment was similar to that of solvatofluorochromic dyes dissolved in toluene (Ph₂N-TTz-Py λₑₘᵢ=˜490 nm and Ph₂N-TTz-NO₂ λₑₘᵢ=˜520 nm). The exemplary composite materials also showed very high fluorescent quantum yields exceeding those observed in non-polar media (Ph₂N-TTz-Py Φ_{F}=97% and Ph₂N-TTz-NO₂ Φ_{F}=70%), and surprisingly long-lived fluorescent lifetimes (Ph₂N-TTz-Py τ_{f}=3.18 ns and Ph₂N-TTz-NO₂ τ_{f}=2.64 ns), indicating well-dispersed, polymer-embedded TTz dyes.

Organic vapor sensitivity was evaluated by exposing the composite films to a variety of organic solvent vapors in a closed spectrofluorometric cell. FIG. 5B shows the emission spectrum of a single exposure of Ph₂N-TTz-NO₂ THF at the saturated solvent vapor pressure. The inset shows detection of 7-67% of saturated solvent vapor pressure (standard deviation percent fluorescence decrease, 45±0.05% at 6.7% saturated THF vapor).

Table 6 below shows emission results for Ph₂N-TTz-NO₂—SIS polymer composites, specifically, maximum emission wavelengths and intensities before, during, and after exposure to organic solvent vapors, as well as the percent of initial fluorescence for samples exposed to saturated solvent vapors. The emission of the Ph₂N-TTz-NO₂ polymer composites decreased significantly when exposed to increasingly more polar solvent vapors, with a 12% decrease when exposed to toluene, and a near 100% decrease when exposed to THF or chloroform at their saturated solvent vapor pressures. A visible red shift was observed from the polymer's emission at 520 nm to when exposed to polar solvents (λ_{emi tol}=544 nm and λ_{emi THF}=570 nm), demonstrating how the achieved solvatofluorochromic effect allows for distinguishing between toluene, ether, THF and DCM solvent vapors. Additionally, not intending to be bound by theory, there was also a red spectral shift due to solvent vapor concentration, likely due to the varying degrees of polarity in the mixed non-polar (SIS polymer) and polar (solvent vapor) environments. The quenching effect of the nitrophenyl allowed a distinct contrast of emission to be easily detected. The fluorescence response speed was less than 1 s when the films were exposed to volatile solvents like DCM and THE, while thicker drop-cast films had slower fluorescence changes (20-30 s).

TABLE 6
Solvent Vapor Sensing for Ph₂N-TTz-NO₂/SIS

| | | | | | | | Percent of Initial | |
|---|---|---|---|---|---|---|---|---|
| | | | | | | | Fluorescence | |
| | λₑₘᵢ (nm) | | | Intensity (counts) | | | During | After |
| Solvent | Before | During | After | Before | During | After | (%) | (%) |
| DCM | 520 | 576 | 535 | 286.1 | 3.27 | 261.9 | 1.1 | 91.5 |
| CHCl₃ | 520 | — | 520 | 499.9 | 0 | 470.7 | 0 | 94.2 |
| Hex | 520 | 500 | 498 | 434.7 | 118.1 | 74.4 | 27.2 | 17.1 |
| THF | 520 | 570 | 520 | 506.4 | 32.4 | 495.1 | 6.4 | 97.8 |
| Ether | 520 | 552 | 512 | 408.8 | 179.6 | 133.2 | 43.9 | 32.6 |
| MeOH | 520 | 538 | 524 | 400.3 | 255.2 | 361.9 | 63.8 | 90.4 |
| EtOH | 520 | 542 | 522 | 515.4 | 354.1 | 481.1 | 68.7 | 93.3 |
| Tol | 520 | 540 | 526 | 496.3 | 437.1 | 503.3 | 88.1 | 101.4 |
| TEA | 520 | — | 523 | 321.3 | 32.6 | 188.2 | 10.0 | 58.6 |
| DEA | 520 | 546 | 521 | 507.6 | 108.9 | 422.7 | 21.4 | 83.3 |

In Table 6 above, the ppm was derived from the vapor pressure of each solvent, calculated from The Yaws Handbook of Vapor Pressure. The ppm and pressure of the solvent below the saturated vapor pressure were calculated from the ideal gas law (PV=nRT), wherein the volume (V) was measured using water displacement of 23.3 mL, the gas constant (R)=0.821 L atm/K mol, the temperature (T)=293.15 K, and the mols, n, were calculated based on the assumption that all the liquid enters the vapor phase.

Table 7 below shows calculated pressure values and percent of saturated vapor pressure for various solvents, using 1 μL of each solvent, using a 4 L flask with a 5-minute solvent exposure.

TABLE 7

| | Std. | | | Solvent | | | % of |
|---|---|---|---|---|---|---|---|
| | Vapor | Saturated | Saturated | with 1 | 1 μL | | Sat. |
| | Pressure | Solvent | (ppm) | μL | (ppm) | Pressure | Vapor |
| Solvent | (atm) | (μmol) | (μmol/mol) | (μmol) | (μmol/mol) | (atm) | Pressure |
| DCM | 0.465 | 449 | 465000 | 15.7 | 16200 | 0.016 | 3.48 |
| CHCl₃ | 0.201 | 195 | 201000 | 12.5 | 12900 | 0.013 | 6.41 |
| Hex | 0.156 | 150 | 156000 | 7.60 | 7860 | 0.008 | 5.05 |
| THF | 0.167 | 161 | 167000 | 12.3 | 12700 | 0.013 | 7.63 |
| THF* | 0.167 | 161 | 167000 | 12.3 | 66 | 0.00007 | 0.04 |
| Ether | 0.576 | 557 | 576000 | 9.62 | 9950 | 0.010 | 1.73 |
| MeOH | 0.117 | 113 | 117000 | 24.7 | 25600 | 0.026 | 21.8 |
| EtOH | 0.059 | 57 | 59000 | 17.1 | 17700 | 0.018 | 30.2 |
| Tol | 0.0294 | 28 | 29000 | 9.41 | 9740 | 0.010 | 33.1 |
| TEA | 0.044 | 43 | 44000 | 7.70 | 7970 | 0.008 | 18.1 |
| DEA | 0.206 | 199 | 206000 | 9.67 | 10000 | 0.010 | 4.86 |

To further evaluate the durability of the inventive exemplary sensors and composite films described herein, the films were exposed to 20 consecutive cycles of THF and DCM vapors. FIG. 5C shows a cycling plot of the max emission during sequential exposure (λₑₘᵢ=520 nm and λₑₓᵢ=445 nm). Minimal fluorescence fluctuations and stable cycling were obtained after 3-4 on/off cycles.

Organic solvent vapors of THF were detected by the exemplary Ph₂N-TTz-NO₂ dye/polymer composite films at low concentrations of saturated vapor pressure (0.04%, 66 ppm), with excellent reproducibility when sensing at a range of organic vapor concentrations. Previously reported optical organic vapor sensors using polymeric swelling induced variation and fluorescence indicated a methanol or acetone solvent vapor detection limit of 100 ppm, while a dye-incorporated, highly porous metal organic framework (MOF) was reported to detect acetone with a detection limit of 60 ppm. Interestingly, unlike the Ph₂N-TTz-NO₂, the Ph₂N-TTz-Py dye retained good fluorescence QY in solvents with increasing polarity such as DCM, ethyl acetate, and CHCl₃. Therefore, polymer sensing using a Ph₂N-TTz-Py dye/polymer composite indicated strong solvatochromic shifts while maintaining strong fluorescence emission intensity when exposed to vapors of solvents with a variety of polarities.

Table 8 below shows the results of solvent vapor sensing testing with a Ph₂N-TTz-Py/SIS composite material.

TABLE 8
Solvent Vapor Sensing Testing for Ph₂N-TTz-Py/SIS

| | | | | | | | Percent of Initial | |
|---|---|---|---|---|---|---|---|---|
| | λₑₘᵢ (nm) | | | Intensity (counts) | | | Fluorescence | |
| Solvent | Before | During | After | Before | During | After | During (%) | After (%) |
| DCM | 491 | 505 | 487 | 876.6 | 533.5 | 620.8 | 60.9 | 70.8 |
| CHCl₃ | 497 | 516 | 497 | 847.5 | 718.3 | 705.4 | 84.8 | 83.2 |
| Hex | 494 | 477 | 460 | 326.9 | 164.2 | 139.8 | 50.2 | 42.8 |
| THF | 496 | 506 | 495 | 804.3 | 698.2 | 825.3 | 86.8 | 102.6 |
| MeTHF | 497 | 511 | 496 | 788.5 | 789.4 | 670.6 | 100.1 | 85.0 |
| Ether | 494 | 497 | 478 | 1001 | 323.5 | 204.6 | 32.3 | 20.4 |
| MeOH | 494 | 515 | 494 | 980.0 | 590.1 | 816.5 | 60.2 | 83.3 |
| EtOH | 494 | 501 | 493 | 758.0 | 432.3 | 477.8 | 57.0 | 63.0 |
| Tol | 494 | 481 | 494 | 943.7 | 831.8 | 502.6 | 88.1 | 53.3 |
| TEA | 494 | 460 | 491 | 864.3 | 760.2 | 621.7 | 88.0 | 71.9 |
| DEA | 493 | 510 | 494 | 792.3 | 605.4 | 724.5 | 76.4 | 91.4 |

In Table 8 above, the ppm was derived from the vapor pressure of each solvent, calculated from The Yaws Handbook of Vapor Pressure. The ppm and pressure of the solvent below the saturated vapor pressure were calculated from the ideal gas law (PV=nRT), wherein the volume (V) was measured using water displacement 23.3 mL, the gas constant (R)=0.821 L atm/K mol, the temperature (T)=293.15 K, and the mols, n, were calculated based on the assumption that all the liquid enters the vapor phase.

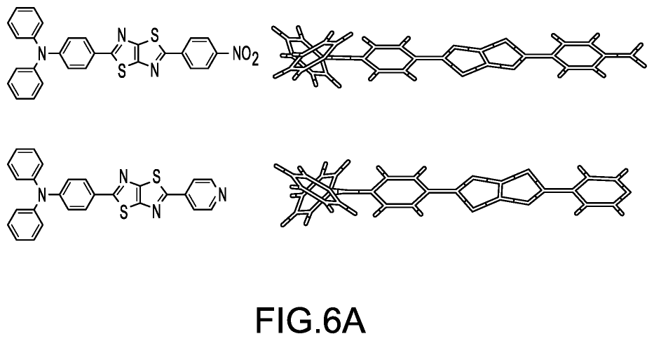

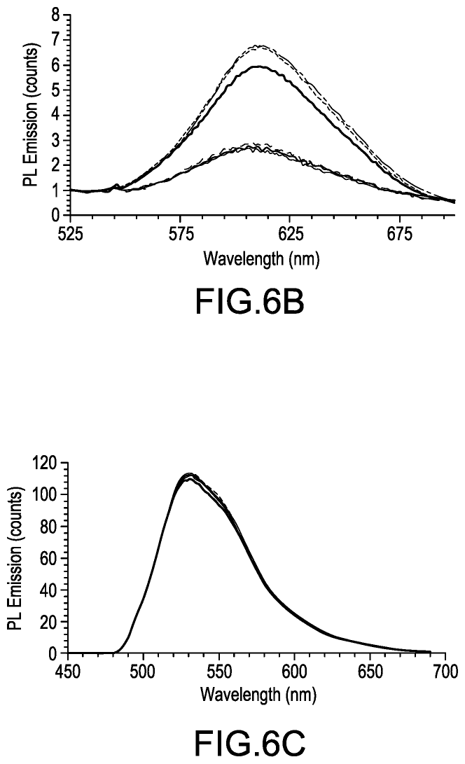

Thin film fluorescence and solvent vapor sensing were also evaluated using compact crystalline films, which were prepared by drop casting DCM solutions onto glass substrates. The TTz compounds herein showed nearly identical crystal structures and packing. However, the fluorescence of the Ph₂N-TTz-NO₂ derivative was significantly red-shifted (λ_{NO}_{₂}=613 nm and λ_{py}=531 nm), as shown in FIG. 6A. In addition, when the crystalline films of the Ph₂N-TTz-Py derivative were exposed to solvent vapors, there was little or no solvatofluorochromic response, whereas the Ph₂N-TTz-NO₂ derivative showed a significant reduction in the PL emission. FIG. 6B shows the emission spectrum of Ph₂N-TTz-NO₂ exposed to DCM vapors. FIG. 6C shows the emission spectrum of Ph₂N-TTz-PY exposed to DCM vapors.

The results above show the superior and advantageous effects achieved by embodiments of composite materials as described herein, which allow for high sensitivity in a variety of applications, including solution-state sensing, temperature sensing, and chemical-responsive, solid-state organic solvent vapor sensing. In the exemplary non-limiting embodiments above, the composite materials comprise asymmetric thiazolothiazole (aTTz) amino-nitro push-pull dyes, and achieve a dual fluorescent, secondary excited state characterized using computational studies to elucidate the ICT nature of the dual fluorescence. The transition dipole moments obtained are among the highest ever reported for small-molecule fluorescent probes. Without being bound by theory, it appears that, in embodiments herein, the fluorescence quenching of the acceptor groups significantly increased the environmental sensitivity of the TTz compounds.

When embedded in a polymer, such as a porous polymer, the TTz compounds herein can be used for sensing a variety of solvent vapors with a range of vapor pressures and functional groups, such as ketones, amines, alcohols, and aromatic compounds. The exemplary optical sensing thin films described above demonstrated good cyclability and low detection limits.

Some additional, non-limiting example embodiments are provided below.

Embodiment 1. A composite material comprising: a thiazolothiazole (TTz) compound of Formula I, Formula II, Formula III, Formula IV, or Formula V:

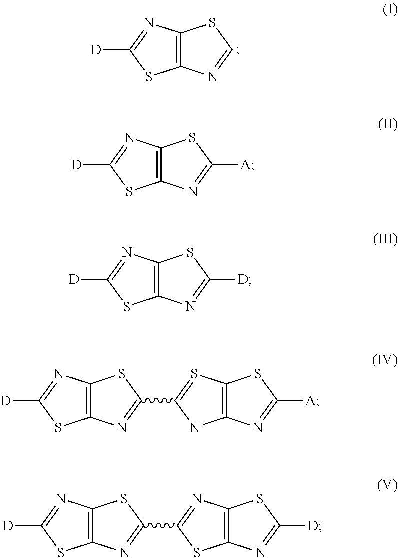

and
a matrix material,
wherein D is an electron donor, A is an electron acceptor, and [symbol] represents a connecting moiety.

Embodiment 2. The composite material of Embodiment 1, wherein the TTz compound comprises the compound of Formula I.

Embodiment 3. The composite material of Embodiment 1, wherein the TTz compound comprises the compound of Formula II.

Embodiment 4. The composite material of Embodiment 1, wherein the TTz compound comprises the compound of Formula III.

Embodiment 5. The composite material of Embodiment 1, wherein the TTz compound comprises the compound of Formula IV.

Embodiment 6. The composite material of any of the preceding Embodiments, wherein A comprises an aryl or heteroaryl moiety.

Embodiment 7. The composite material of any of the preceding Embodiments, wherein A comprises a nitroaromatic moiety.

Embodiment 8. The composite material of Embodiment 7, wherein the nitroaromatic moiety comprises a nitrophenyl moiety.

Embodiment 9. The composite material of any of the preceding Embodiments, wherein D comprises an aryl or heteroaryl moiety.

Embodiment 10. The composite material of any of the preceding Embodiments, wherein D comprises a dialkylamino moiety.

Embodiment 11. The composite material of any of the preceding Embodiments, wherein D comprises a diphenylamino moiety.

Embodiment 12. The composite material of any of the preceding Embodiments, wherein at least one nitrogen of the TTz compound is substituted with a substituent selected from alkyl, heteroalkyl, cycloalkyl, heterocycloalkyl, alkenyl, heteroalkenyl, cycloalkenyl, heterocycloalkenyl, aryl, and heteroaryl.

Embodiment 13. The composite material of any of the preceding Embodiments, wherein more than one nitrogen of the TTz compound is substituted with a substituent selected from alkyl, heteroalkyl, cycloalkyl, heterocycloalkyl, alkenyl, heteroalkenyl, cycloalkenyl, heterocycloalkenyl, aryl, and heteroaryl.

Embodiment 14. The composite material of any of the preceding Embodiments, wherein at least one nitrogen is substituted with a heteroalkyl substituent.

Embodiment 15. The composite material of any of the preceding Embodiments, wherein at least one nitrogen is substituted with a quaternary amine moiety.

Embodiment 16. The composite material of any of the preceding Embodiments, wherein the TTz compound has the following structure:

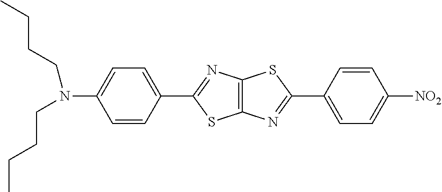 [SMILES: CCCCN(CCCC)c1ccc(-c2nc3sc(-c4ccc([N+](=O)[O-])cc4)nc3s2)cc1]

(which can be denoted as Bu₂N-TTz-NO₂).

Embodiment 17. The composite material of any of the preceding Embodiments, wherein the TTz compound has the following structure:

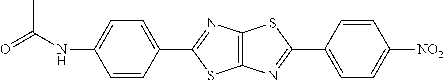 [SMILES: CC(=O)Nc1ccc(-c2nc3sc(-c4ccc([N+](=O)[O-])cc4)nc3s2)cc1]

(which can be denoted as AcNH-TTz-NO₂).

Embodiment 18. The composite material of any of the preceding Embodiments, wherein the TTz compound has the following structure:

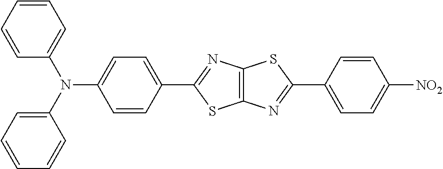 [SMILES: O=[N+]([O-])c1ccc(-c2nc3sc(-c4ccc(N(c5ccccc5)c5ccccc5)cc4)nc3s2)cc1]

(which can be denoted as Ph₂N-TTz-NO₂).

Embodiment 19. The composite material of any of the preceding Embodiments, wherein the TTz compound has the following structure:

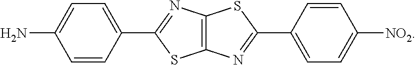 [SMILES: Nc1ccc(-c2nc3sc(-c4ccc([N+](=O)[O-])cc4)nc3s2)cc1]

(which can be denoted as H₂N-TTz-NO₂).

Embodiment 20. The composite material of any of the preceding Embodiments, wherein the TTz compound has the following structure:

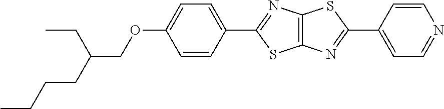 [SMILES: CCCCC(CC)COc1ccc(-c2nc3sc(-c4ccncc4)nc3s2)cc1]

(which can be denoted as EHOPh-TTz-Py).

Embodiment 21. The composite material of any of the preceding Embodiments, wherein the TTz compound has the following structure:

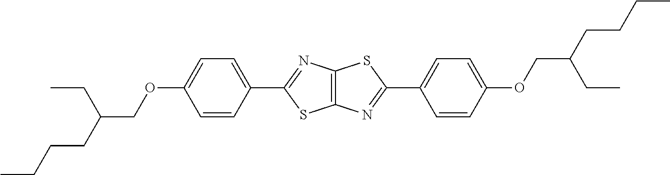 [SMILES: CCCCC(CC)COc1ccc(-c2nc3sc(-c4ccc(OCC(CC)CCCC)cc4)nc3s2)cc1]

(which can be denoted as (EHOPh)₂-TTz).

Embodiment 22. The composite material of any of the preceding Embodiments, wherein the TTz compound is a fluorophore.

Embodiment 23. The composite material of any of the preceding Embodiments, wherein the TTz compound exhibits solvatofluorochromism.

Embodiment 24. The composite material of any of the preceding Embodiments, wherein the TTz compound is embedded in the matrix material.

Embodiment 25. The composite material of any of the preceding Embodiments, wherein the TTz compound is covalently attached to the matrix material.

Embodiment 26. The composite material of any of the preceding Embodiments, wherein the matrix material is non-degrading to the TTz compound.

Embodiment 27. The composite material of any of the preceding Embodiments, wherein the matrix material comprises a block copolymer.

Embodiment 28. The composite material of any of the preceding Embodiments, wherein the matrix material comprises a styrene-isoprene-styrene (SIS) block copolymer.

Embodiment 29. The composite material of any of the preceding Embodiments, wherein the matrix material comprises a poly(dimethylsiloxane).

Embodiment 30. The composite material of any of the preceding Embodiments, wherein the matrix material comprises one or more of polymethyl methacrylate, poly(methyl methacrylate-co-methacrylic acid), polystyrene, polycarbonate, polypropylene, polyvinylpyrrolidone, poly(styrene-butadiene-styrene), polyethylene glycol, polyethylene glycol acrylate, polypropylene glycol, polyethylene glycol diacrylate, poly(4-vinylpyridine), polyethylene glycol methacrylate, poly(perfluorosulfonic acid-co-tetrafluoroethylene), polyvinyl alcohol, polyacrylonitrile, and polytripropylene glycol diacrylate, or combinations thereof.

Embodiment 31. The composite material of any of the preceding Embodiments, further comprising a chromophore different from the TTz compound.

Embodiment 32. The composite material of any of the preceding Embodiments, further comprising a fluorophore different from the TTz compound.

Embodiment 33. A sensor comprising the composite material of any of the preceding Embodiments.

Embodiment 34. An optical sensor comprising the composite material of any of Embodiments 1-32.

Embodiment 35. A sensor comprising the composite material of any of Embodiments 1-32, wherein the sensor is reversible.

Embodiment 36. A sensor comprising the composite material of any of Embodiments 1-32, wherein the sensor is irreversible.

Embodiment 37. A method of sensing comprising:
providing the composite material of any of Embodiments 1-32;
exposing the composite material to a fluid; and
detecting the presence or absence of an analyte in the fluid.

Embodiment 38. The method of sensing according to Embodiment 37, wherein detecting the presence or absence of the analyte comprises observing or detecting a color change or a spectrographic change of the composite material.

Embodiment 39. The method of sensing according to any of Embodiments 37-38, wherein the fluid comprises a gas.

Embodiment 40. The method of sensing according to any of Embodiments 37-38, wherein the fluid comprises a liquid.

Embodiment 41. The method of sensing according to any of Embodiments 37-40, wherein the matrix material of the composite material is permeable to the analyte.

Embodiment 42. The method of sensing according to any of Embodiments 37-40, wherein the matrix material of the composite material is selectively permeable to the analyte.

Embodiment 43. The method of sensing according to any of Embodiments 37-42, wherein the matrix material of the composite material is non-degrading to the TTz compound.

Embodiment 44. The method of sensing according to any of Embodiments 37-43, wherein the analyte does not dissolve the matrix material of the composite material.

Embodiment 45. A method of detecting a temperature change, the method comprising:
providing the composite material of any of Embodiments 1-32;
exposing the composite material to a first temperature;
exposing the composite material to a second temperature different from the first temperature; and
detecting a change from the first temperature to the second temperature.

All patent documents referred to herein are incorporated by reference in their entireties. Various embodiments have been described herein, but it should be recognized that these embodiments are merely illustrative. Numerous modifications and adaptations will be readily apparent to those skilled in the art without departing from the spirit and scope of the invention.

1. A composite material comprising:
a thiazolothiazole (TTz) compound of Formula I, Formula II, Formula II, Formula IV, or Formula V: 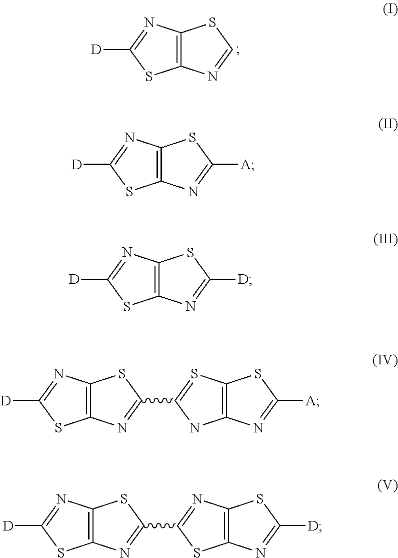
and
a matrix material,
wherein D is an electron donor, A is an electron acceptor, and [symbol] represents a connecting moiety.

2-5. (canceled)

6. The composite material of claim 1, wherein A comprises an aryl or heteroaryl moiety.

7. The composite material of claim 1, wherein A comprises a nitroaromatic moiety.

8. (canceled)

9. The composite material of claim 1, wherein D comprises an aryl or heteroaryl moiety.

10. The composite material of claim 1, wherein D comprises a dialkylamino moiety.

11. (canceled)

12. The composite material of claim 1, wherein at least one nitrogen of the TTz compound is substituted with a substituent selected from alkyl, heteroalkyl, cycloalkyl, heterocycloalkyl, alkenyl, heteroalkenyl, cycloalkenyl, heterocycloalkenyl, aryl, and heteroaryl.

13. (canceled)

14. (canceled)

15. The composite material of claim 12, wherein the heteroalkyl substituent comprises a quaternary amine moiety.

16. The composite material of claim 1, wherein the TTz compound has the following structure:

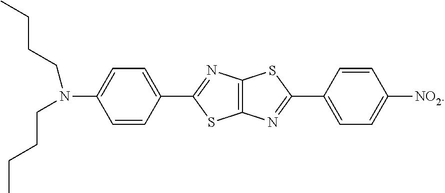 [SMILES: CCCCN(CCCC)c1ccc(-c2nc3sc(-c4ccc([N+](=O)[O-])cc4)nc3s2)cc1]

17. The composite material of claim 1, wherein the TTz compound has the following structure:

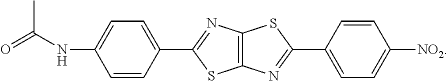 [SMILES: CC(=O)Nc1ccc(-c2nc3sc(-c4ccc([N+](=O)[O-])cc4)nc3s2)cc1]

18. The composite material of claim 1, wherein the TTz compound has the following structure:

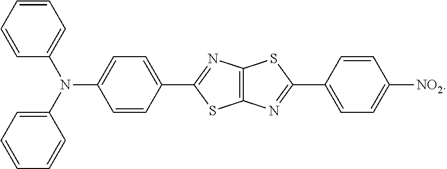 [SMILES: O=[N+]([O-])c1ccc(-c2nc3sc(-c4ccc(N(c5ccccc5)c5ccccc5)cc4)nc3s2)cc1]

19. The composite material of claim 1, wherein the TTz compound has the following structure:

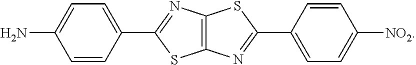 [SMILES: Nc1ccc(-c2nc3sc(-c4ccc([N+](=O)[O-])cc4)nc3s2)cc1]

20. The composite material of claim 1, wherein the TTz compound has the following structure:

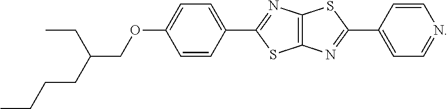 [SMILES: CCCCC(CC)COc1ccc(-c2nc3sc(-c4ccncc4)nc3s2)cc1]

21. The composite material of claim 1, wherein the TTz compound has the following structure:

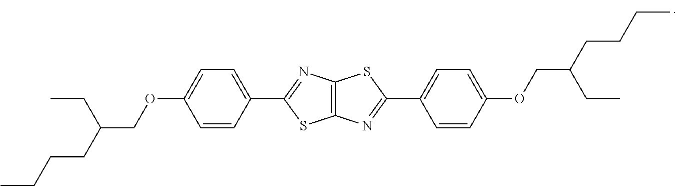 [SMILES: CCCCC(CC)COc1ccc(-c2nc3sc(-c4ccc(OCC(CC)CCCC)cc4)nc3s2)cc1]

22. The composite material of claim 1, wherein the TTz compound is a fluorophore.

23. The composite material of claim 1, wherein the TTz compound exhibits solvatofluorochromism.

24. (canceled)

25. The composite material of claim 1, wherein the TTz compound is covalently attached to the matrix material.

26. (canceled)

27. The composite material of claim 1, wherein the matrix material comprises a block copolymer.

28. The composite material of claim 27, wherein the block copolymer is a styrene-isoprene-styrene (SIS) block copolymer.

29. The composite material of claim 1, wherein the matrix material comprises a poly(dimethylsiloxane).

30. The composite material of claim 1, wherein the matrix material comprises one or more of polymethyl methacrylate, poly(methyl methacrylate-co-methacrylic acid), polystyrene, polycarbonate, polypropylene, polyvinylpyrrolidone, poly(styrene-butadiene-styrene), polyethylene glycol, polyethylene glycol acrylate, polypropylene glycol, polyethylene glycol diacrylate, poly(4-vinylpyridine), polyethylene glycol methacrylate, poly(perfluorosulfonic acid-co-tetrafluoroethylene), polyvinyl alcohol, polyacrylonitrile, and polytripropylene glycol diacrylate, or combinations thereof.

31. The composite material of claim 1, further comprising a chromophore or fluorophore different from the TTz compound.

32. (canceled)

33. A sensor comprising the composite material of claim 1.

34. The sensor of claim 31, wherein the sensor is an optical sensor.

35. The sensor of claim 31, wherein the sensor is reversible.

36. (canceled)

37. A method of sensing comprising:
providing the composite material of claim 1;
exposing the composite material to a fluid; and
detecting the presence or absence of an analyte in the fluid.

38. The method of claim 37, wherein detecting the presence or absence of the analyte comprises observing or detecting a color change or a spectrographic change of the composite material.

39. (canceled)

40. (canceled)

41. The method of claim 37, wherein the matrix material of the composite material is permeable to the analyte.

42. The method of claim 37, wherein the matrix material of the composite material is selectively permeable to the analyte.

43. The method of claim 37, wherein the matrix material of the composite material is non-degrading to the TTz compound.

44. The method of claim 37, wherein the analyte does not dissolve the matrix material of the composite material.

45. A method of detecting a temperature change, the method comprising:
providing the composite material of claim 1;
exposing the composite material to a first temperature;
exposing the composite material to a second temperature different from the first temperature; and
detecting a change from the first temperature to the second temperature.
